(19) United States
(12) Patent Application Publication
(10) Pub. No.: US 2024/0416280 A1
(43) Pub. Date: Dec. 19, 2024

(54) EMISSIONS TREATMENT ARTICLES WITH INORGANIC FILTRATION DEPOSITS AND CATALYTIC MATERIAL

(71) Applicant: Corning Incorporated, CORNING, NY (US)

(72) Inventors: Vishwanath Ganpat Deshmane, Chesterbroo, PA (US); Kristyn Lee Penhollow, CORNING, NY (US)

(21) Appl. No.: 18/702,986

(22) PCT Filed: Nov. 14, 2022
(86) PCT No.: PCT/US2022/049821

§ 371 Date: Apr. 19, 2024

Related U.S. Application Data
(60) Provisional application No. 63/282,831, filed on Nov. 24, 2021.

(51) Int. Cl. B01D 53/94; B01J 35/57; B01J 37/02

(52) U.S. Cl. CPC B01D 53/944; B01D 53/9472; B01J 35/57; B01J 37/0215; B01D 2255/9155; B01D 2255/9205; B01D 2258/01

(57) ABSTRACT

A filtration article comprises inorganic deposits disposed at inlet sides of porous ceramic base portions of a plugged honeycomb filter body; and a catalytic material, e.g., a three-way conversion (TWC) catalytic material, disposed at outlet sides of porous ceramic base portions of the plugged honeycomb filter body. Interposing regions are located between the inlet sides and the outlet sides of the porous ceramic base portions. A majority or all of the inorganic deposits are spaced away from a majority of the catalytic material by the interposing region at a given axial location and/or across an entire axial length. The inorganic deposits and the porous ceramic base portions are not hydrophobic.

### CROSS REFERENCE TO RELATED APPLICATION

This application claims the benefit of priority under 35 U.S.C. § 119 of U.S. Provisional Application Ser. No. 63/282,831 filed on Nov. 24, 2021, the content of which is relied upon and incorporated herein by reference in its entirety.

### BACKGROUND

### Field

The present specification relates to articles for emissions treatment, the articles comprising porous ceramic walls, such as plugged honeycomb filter bodies, comprising inorganic deposits disposed on walls defining inlet channels of the plugged honeycomb filter bodies and a catalytic material on or within the filter body on the outlet side, and methods of making and using such articles.

### Technical Background

Wall flow filters are employed to remove particulates from fluid exhaust streams, such as from combustion engine exhaust. Examples include ceramic soot filters used to remove particulates from diesel engine exhaust gases; and gasoline particulate filters (GPF) used to remove particulates from gasoline engine exhaust gases. For wall flow filters, exhaust gas to be filtered enters inlet cells and passes through the cell walls to exit the filter via outlet channels, with the particulates being trapped on or within the inlet cell walls as the gas traverses and then exits the filter.

GPFs can be used in conjunction with gasoline direct injection (GDI) engines, which emit more particulates than conventional gasoline engines.

Three-way conversion (TWC) catalysts are used to convert combustion by-products such as carbon monoxides, nitrogen oxides, and hydrocarbons emitted from gasoline engines.

### SUMMARY

Aspects of the disclosure pertain to porous bodies and methods for their manufacture and use.

In an aspect, filtration article comprises: a plugged honeycomb filter body comprises: intersecting porous walls extending an axial length in an axial direction from a proximal end to a distal end of the honeycomb body and defining a plurality of axial channels comprised of inlet channels, which are plugged at the distal end of the plugged honeycomb filter body, and outlet channels, which are plugged at the proximal end of the plugged honeycomb filter body. The porous walls comprises: porous ceramic base portions with a plurality of pores and an average thickness and having inlet sides and outlet sides; inlet surfaces defining the inlet channels; outlet surfaces defining the outlet channels; inorganic deposits disposed at the inlet sides of the porous ceramic base portions, and catalytic material disposed at the outlet sides of the porous ceramic base portions on and/or within the porous ceramic base portions. The inlet surfaces are comprised of exposed inorganic deposits and any areas of the porous ceramic base portion exposed to the inlet channels. The outlet surfaces are comprised of any catalytic material exposed to the outlet channels, and any areas of the porous ceramic base portion exposed to the outlet channels. The porous ceramic base portions comprise interposing regions located between the inlet sides and the outlet sides of the porous ceramic base portions, wherein a majority or all of the inorganic deposits are spaced away from a majority of the catalytic material by the interposing region at a given axial location and/or across an entire axial length.

In an aspect, method for making a filtration article comprised of a honeycomb body comprising intersecting porous walls extending an axial length in an axial direction from a proximal end to a distal end of the honeycomb body and defining a plurality of axial channels comprised of inlet channels, which are plugged at or near the distal end of the plugged honeycomb filter body, and outlet channels, which are plugged at or near the proximal end of the plugged honeycomb filter body, wherein the porous walls comprise: porous ceramic base portions with a plurality of pores and an average thickness, and having inlet sides facing the inlet channels and outlet sides facing the outlet channels comprises the following. Catalytic material is applied at the outlet sides such that a desired amount of catalytic material is disposed on, in, or on and in the walls, without the catalytic material reaching the inlet sides to yield a catalytically dense region. The plugged honeycomb filter body is exposed to a surface treatment to deposit inorganic deposits at the inlet sides to yield an inorganic deposit region; wherein a majority of the catalytic material is spaced away from a majority or all of the inorganic deposits at a given axial location by interposing regions disposed between the inorganic deposit region and the catalytically dense region.

In an aspect, method for making a filtration article comprises: applying a catalytic material at outlet sides of porous ceramic base portions a plugged honeycomb filter body comprising intersecting porous walls; and exposing the plugged honeycomb filter body to a surface treatment to deposit inorganic deposits at inlet sides of the porous ceramic base portions; wherein a majority of the catalytic material is disposed separate from a majority or all of the inorganic deposits by interposing regions located between the inlet sides and the outlet sides of the porous ceramic base portions.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a honeycomb body according to embodiments disclosed and described herein;

FIG. 2 schematically depicts a particulate filter according to embodiments disclosed and described herein;

FIG. 3 is a cross-sectional longitudinal view of the particulate filter shown in FIG. 2;

FIG. 4 is a flowchart depicting an exemplary embodiment of a process of forming deposits of inorganic material on a substrate according to embodiments disclosed herein; and

FIG. 5 is a flowchart depicting an exemplary embodiment of a process of preparing an emissions treatment article according to embodiments disclosed herein.

FIG. 6 is a cross-sectional schematic view of a portion of a porous wall according to embodiments disclosed herein;

FIG. 7 is a cross-sectional schematic view of a portion of a porous wall according to embodiments disclosed herein;

FIG. 8 is a cross-sectional longitudinal view of an article according to embodiments disclosed herein;

FIG. 9 is a cross-sectional longitudinal view of an article according to embodiments disclosed herein;

FIG. 10 is a cross-sectional longitudinal view of an article according to embodiments disclosed herein;

FIG. 11 is a schematic drawing of a filtration efficiency measurement apparatus;

FIG. 12 is a graph of pressure drop (kPa) versus soot loading; and

FIG. 13 is a graph of filtration efficiency for a bare honeycomb body example and for a honeycomb body having inorganic material deposited on inlet sides of the walls of the matrix of walls plus catalytic-type material applied to the outlet sides of the walls.

### DETAILED DESCRIPTION

Reference will now be made in detail to embodiments of articles for emissions treatment, for example, filtration articles, comprising a plugged honeycomb filter body comprising inorganic deposits disposed on walls defining inlet channels of the plugged honeycomb filter body and a catalytic material, in particular, a three-way conversion (TWC) catalytic material, on or within pores of porous ceramic walls of the plugged honeycomb filter body, embodiments of which are illustrated in the accompanying drawings. Whenever possible, the same reference numerals will be used throughout the drawings to refer to the same or like parts.

Aspects herein relate to articles, emissions treatment articles, in particular filtration articles, which are effective for filtration of particulates from gaseous streams and/or for catalytically converting combustion by-products such as carbon monoxides, nitrogen oxides, and hydrocarbons. Aspects also relate to manufacture of such articles and their use.

Advantageously, articles disclosed herein including inorganic deposits disposed on walls defining inlet channels of a plugged honeycomb filter bodies and a catalytic material, such as a three-way conversion (TWC) catalytic material at outlet sides of the plugged honeycomb filter bodies provide both high filtration efficiency and low pressure drop. There is substantial separation of the inorganic deposits and the catalytic material in that there is little to no overlap of these materials through the honeycomb walls. In this way, a low pressure drop penalty is realized and/or with acceptable to improved catalytic conversion efficiency by keeping the inorganic deposits substantially separated from the catalytic material. Reference to “separation from” or “disposed separate from” and the like means that there is no intentional mixing of the catalytic material, e.g., TWC catalytic material, and the inorganic deposits, but some minor migration of these materials and intermingling of these may permissibly occur for example at interfaces without unacceptable effects on performance.

To achieve this substantial separation of the inorganic deposits and the TWC catalytic material, the TWC catalytic material is first coated onto walls and/or into pores of the outlet side of the honeycomb filter body. Thereafter, the inorganic deposits are deposited on inlet walls of the honeycomb filter body.

The “inorganic deposits” of the honeycomb filter body are preferably non-engine inorganic deposits. That is, the inorganic deposits of the honeycomb filter body are not reliant on deposits of soot or metals or the like coming from the engine exhaust itself. For example, the inorganic deposits of the honeycomb filter body are applied to the article itself at manufacture and prior to connection to an engine exhaust system. In one or more embodiments, the inorganic deposits of the honeycomb body are free from rare earth oxides such as ceria, lanthana, and yttria. In one or more embodiments, the inorganic deposits are free from catalyst, for example, an oxidation catalyst such as a platinum group metal (e.g., platinum, palladium and rhodium) or a selective catalytic reduction catalyst such as a copper, a nickel or an iron promoted molecular sieve (e.g., a zeolite). In one or more embodiments, the inorganic deposits are comprised of particles, aggregates, or agglomerates of one or more refractory materials, metals, ceramics, oxides, nitrides, glasses, or combinations thereof. Inorganic deposits can comprise: inorganic material, inorganic particulate material, and/or inorganic particles.

In embodiments, a loading of the catalytic material is between 0.5 g/in³ (30 g/L) to 2.5 g/in³ (150 g/L) within the honeycomb body, and all values and subranges therebetween. Within the honeycomb body refers to locations on walls and/or in pores of the walls. In specific embodiments, the loading of the catalytic material is in a range of from 35 to 145 g/L, 40 to 140 g/L, 50 to 130 g/L, 60 to 125 g/L, 70 to 120 g/L, 80 to 110 g/L, 90 to 100 g/L within the honeycomb body. Loading of the catalytic material is weight of added material in grams divided by the geometric part volume in liters. The geometric part volume is based on outer dimensions of the honeycomb filter body (or plugged honeycomb body).

In embodiments, the inorganic deposits comprise one or more inorganic materials, such as one or more ceramic or refractory materials. In embodiments, the inorganic deposits is disposed on the walls to provide enhanced filtration efficiency, both locally through and at the wall and globally through the honeycomb body, at least in the initial use of the honeycomb body as a filter following a clean state, or regenerated state, of the honeycomb body, for example such as before accumulation of ash and/or soot occurs inside the honeycomb body after use of the honeycomb body as a filter.

In embodiments, the inorganic deposits form a filtration material.

In one aspect, the filtration material is present as a layer disposed on the surface of one or more of the base portion of the walls of the honeycomb structure. The layer is preferably porous to allow the gas flow through the wall. In embodiments, the layer is present as a continuous coating over at least part of the, or over the entire, surface of the one or more walls. In embodiments of this aspect, the filtration material is flame-deposited filtration material.

In another aspect, the filtration material is present as a plurality of discrete regions of filtration material disposed on the surface of one or more of the base portions of the walls of the honeycomb structure. The filtration material may partially block a portion of some of the pores of the porous walls, while still allowing gas flow through the wall. In embodiments of this aspect, the filtration material is aerosol-deposited filtration material. In preferred embodiments, the filtration material comprises a plurality of inorganic particle agglomerates, wherein the agglomerates are comprised of particles, preferably nanoparticles, of inorganic or ceramic or refractory material. The agglomerates are preferably porous, thereby allowing gas to flow through the agglomerates, and in a preferred aspect are spherical agglomerates. The filtration material may further be comprised of aggregates of such agglomerates.

In embodiments, a honeycomb body comprises a porous ceramic honeycomb body comprising a first end (or inlet end), a second end (or outlet end), and a plurality of walls having wall surfaces defining a plurality of inner channels. A deposited material such as a filtration material, such as inorganic deposits, which may be a porous inorganic layer, is disposed on one or more of the wall surfaces of the base portion of the walls of the honeycomb body. The inorganic deposits, which may be a continuous porous inorganic layer has a porosity in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%, and a continuous layer of the inorganic deposits has an average thickness of greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm. Average thickness may be determined by an overall average thickness (all walls in the honeycomb body) along entire axial length from a proximal end (inlet) to a distal end (outlet). Various embodiments of honeycomb bodies and methods for forming such honeycomb bodies will be described herein with specific reference to the appended drawings.

The material preferably comprises a filtration material, and in embodiments comprises an inorganic layer. According to one or more embodiments, the inorganic layer provided herein comprises a discontinuous deposit formation disposed axially from the inlet end to the outlet end comprising discrete and disconnected patches of material or filtration material and binder comprised of primary particles in secondary aggregate particles or agglomerates that are substantially spherical. In one or more embodiments, the primary particles are non-spherical. In one or more embodiments, “substantially spherical” refers to an agglomerate having a circularity in cross section in a range of from about 0.8 to about 1 or from about 0.9 to about 1, with 1 representing a perfect circle. In one or more embodiments, 75% of the primary particles deposited on the honeycomb body have a circularity of less than 0.8. In one or more embodiments, the aggregate particles or agglomerates deposited on the honeycomb body have an average circularity greater than 0.9, greater than 0.95, greater than 0.96, greater than 0.97, greater than 0.98, or greater than 0.99.

Circularity can be measured using a scanning electron microscope (SEM). The term “circularity of the cross-section (or simply circularity)” is a value expressed using the equation shown below. A circle having a circularity of 1 is a perfect circle. Circularity=(4π×cross-sectional area)/(length of circumference of the cross-section)².

In one or more embodiments, the “filtration material” provides enhanced filtration efficiency to the honeycomb body, both locally through and at the wall and globally through the honeycomb body. In one or more embodiments, “filtration material” is not catalytically active in that it does not react with components of a gaseous mixture of an exhaust stream at certain temperatures.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”.

A honeycomb body, as referred to herein, comprises a shaped honeycomb structure of intersecting walls to form cells that define channels. The honeycomb structure may be formed, extruded, or molded, and may be of a selected shape or size. For example, a ceramic honeycomb structure may be a filter body formed from cordierite or other suitable ceramic material.

A honeycomb body, as referred to herein, may also comprise a shaped ceramic honeycomb structure having at least one layer applied to wall surfaces of a porous ceramic base portion of the honeycomb structure, which can be configured to filter particulate matter from a gas stream, such as by plugging or sealing certain channels to force gas flow through the porous walls. There may be more than one application or layer applied to the same location of the honeycomb structure. The layer may comprise inorganic material, organic material or both inorganic material and organic material. For example, a honeycomb body may, in one or more embodiments, be formed from cordierite or other ceramic material and have a porous inorganic layer applied to surfaces of the cordierite honeycomb structure.

A honeycomb body of one or more embodiments may comprise a honeycomb structure which serves as a base portion and deposited material such as a filtration material, which may be a porous inorganic layer disposed on one or more base portions of walls of the honeycomb structure. In embodiments, the deposited material such as a filtration material, which may be a porous inorganic layer is applied to surfaces of base portions of the walls present within honeycomb structure, where the walls have surfaces that define a plurality of inner channels.

The inner channels may have various cross-sectional shapes, such as circles, ovals, triangles, squares, pentagons, hexagons, or tessellated combinations or any of these, for example, and may be arranged in a suitable geometric configuration. The inner channels may be discrete or intersecting and may extend through the honeycomb body from a first end thereof to a second end thereof, which is opposite the first end.

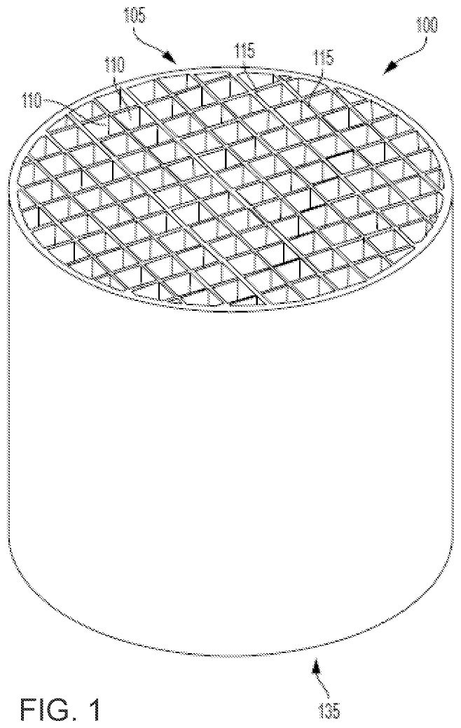

With reference now to FIG. 1, a honeycomb body 100 according to one or more embodiments shown and described herein is depicted. The honeycomb body 100 may, in embodiments, comprise a plurality of walls 115 defining a plurality of inner channels 110. The plurality of inner channels 110 and intersecting channel walls 115 extend between first end 105, which may be an inlet end, and second end 135, which may be an outlet end, of the honeycomb body.

In one or more embodiments, the honeycomb body may be formed from cordierite, aluminum titanate, enstatite, mullite, forsterite, corundum (SiC), spinel, sapphirine, or periclase, or combinations thereof. In general, cordierite is a solid phase solution having a composition according to the formula (Mg,Fe)₂Al₃ (Si₅AlO₁₈). During manufacture, the pore size of the ceramic material may be controlled, the porosity of the ceramic material may be controlled, and the pore size distribution of the ceramic material may be controlled, for example by varying the particle sizes of the ceramic raw materials. In addition, pore formers may be included in ceramic batches used to form the honeycomb body and the pore structure.

In embodiments, walls of the honeycomb body may have an average thickness from greater than or equal to 25 μm to less than or equal to 300 μm, such as from greater than or equal to 25 μm to less than or equal to 250 μm, greater than or equal to 45 μm to less than or equal to 230 μm, greater than or equal to 65 μm to less than or equal to 210 μm, greater than or equal to 65 μm to less than or equal to 190 μm, or greater than or equal to 85 μm to less than or equal to 170 μm.

The walls of the honeycomb body can be described to have a base portion comprised of a bulk portion (also referred to herein as the bulk), and deposited surface portions (also referred to herein as deposits or the inorganic deposit regions) disposed mostly or entirely on the surface of the base portion of the wall of the honeycomb body. The deposited surface portion (or inorganic deposit region) of the walls may extend from a surface of a base portion of a wall of the honeycomb body toward the center or bulk portion of the wall of the honeycomb body. The inorganic deposit region or deposited surface portion may extend from 0 (zero) to a depth of about 10 μm into the base portion of the wall of the honeycomb body. In embodiments, the inorganic deposit region or deposited surface portion may extend about 5 μm, about 7 μm, or about 9 μm (i.e., a depth of 0 (zero)) into the base portion of the wall. The bulk portion of the honeycomb body constitutes the thickness of wall minus the deposited surface portions on both sides of the wall (where for example a deposited surface portion on the outlet side may be filtration material or catalytic material).

Thus, the bulk portion of the honeycomb body may be determined by the following equation:

$${t}_{bulk} = {t}_{total} - 2 {t}_{surface}$$

where t_{bulk} is the thickness of the bulk portion, tₜₒₜₐₗ is the total thickness of the wall and t_{surface} is the thickness of the wall surface deposits.

In one or more embodiments, the base portion of the honeycomb body (prior to applying any material or filtration material or layer) has a bulk median pore size from greater than or equal to 7 μm to less than or equal to 25 μm, such as from greater than or equal to 12 μm to less than or equal to 22 μm, or from greater than or equal to 12 μm to less than or equal to 18 μm. For example, in embodiments, the base portion of the honeycomb body may have bulk median pore sizes of about 10 μm, about 11 μm, about 12 μm, about 13 μm, about 14 μm, about 15 μm, about 16 μm, about 17 μm, about 18 μm, about 19 μm, or about 20 μm. Generally, pore sizes of any given material typically exist in a statistical distribution. Thus, the term “median pore size” or “d₅₀” (prior to applying any material or filtration material or layer) refers to a length measurement, above which the pore sizes of 50% of the pores lie and below which the pore sizes of the remaining 50% of the pores lie, based on the statistical distribution of all the pores. Pores in ceramic bodies can be manufactured by at least one of: (1) inorganic batch material particle size and size distributions; (2) furnace/heat treatment firing time and temperature schedules; (3) furnace atmosphere (e.g., low or high oxygen and/or water content), as well as; (4) pore formers, such as, for example, polymers and polymer particles, starches, wood flour, hollow inorganic particles and/or graphite/carbon particles.

In specific embodiments, the median pore size (d₅₀) of the base portion of the honeycomb body (prior to applying any material or filtration material or layer) is in a range of from 10 μm to about 16 μm, for example 13-14 μm, and the d₁₀ refers to a length measurement, above which the pore sizes of 90% of the pores lie and below which the pore sizes of the remaining 10% of the pores lie, based on the statistical distribution of all the pores is about 7 μm. In specific embodiments, the d₉₀ refers to a length measurement, above which the pore sizes of 10% of the pores of the base portion of the honeycomb body (prior to applying any material or filtration material or layer) lie and below which the pore sizes of the remaining 90% of the pores lie, based on the statistical distribution of all the pores is about 30 μm. In specific embodiments, the median or average diameter (D₅₀) of the secondary aggregate particles or agglomerates is about 2 microns. In specific embodiments, it has been determined that when the agglomerate median size D₅₀ and the median wall pore size of the bulk honeycomb body d₅₀ is such that there is a ratio of agglomerate median size D₅₀ to median wall pore size of the bulk honeycomb body d₅₀ is in a range of from 5:1 to 16:1, excellent filtration efficiency results and low pressure drop results are achieved. In more specific embodiments, a ratio of agglomerate median size D₅₀ to median wall pore size of the base portion of honeycomb body d₅₀ (prior to applying any material or filtration material or layer) is in a range of from 6:1 to 16:1, 7:1 to 16:1, 8:1 to 16:1, 9:1 to 16:1, 10:1 to 16:1, 11:1 to 16:1 or 12:1 to 6:1 provide excellent filtration efficiency results and low pressure drop results.

In embodiments, the base portion of the honeycomb body may have bulk porosities, not counting a coating, of from greater than or equal to 50% to less than or equal to 75% as measured by mercury intrusion porosimetry. Other methods for measuring porosity include scanning electron microscopy (SEM) and X-ray tomography, these two methods in particular are valuable for measuring surface porosity and bulk porosity independent from one another. In one or more embodiments, the bulk porosity of the honeycomb body may be in a range of from about 50% to about 75%, in a range of from about 50% to about 70%, in a range of from about 55% to about 70%, in a range of from about 60% to about 70%, in a range of from about 50% to about 65%, in a range of from about 50% to about 60%, in a range of from about 50% to about 58%, in a range of from about 50% to about 56%, or in a range of from about 50% to about 54%, for example.

In one or more embodiments, the inorganic deposit region of the honeycomb body has a surface median pore size from greater than or equal to 7 μm to less than or equal to 30 μm, such as from 10 μm to less than or equal to 25 μm, or 13 μm to less than or equal to 22 μm, or greater than or equal to 8 μm to less than or equal to 15 μm, or from greater than or equal to 10 μm to less than or equal to 14 μm. For example, in embodiments, the inorganic deposit region of the honeycomb body may have surface median pore sizes of about 8 μm, about 9 μm, about 10 μm, about 11 μm, about 12 μm, about 13 μm, about 14 μm, or about 15 μm, or about 13-20 μm, or about 13-15 μm, or about 15-22 μm, or about 16-22 μm, or about 17-22 μm, or about 18-22 μm, or about 19-22 μm.

In embodiments, the surface of the base portion of the honeycomb body may have surface porosities, prior to application of a layer, of from greater than or equal to 35% to less than or equal to 75% as measured by mercury intrusion porosimetry, SEM, or X-ray tomography. In one or more embodiments, the surface porosity of the base portion of the honeycomb body may be less than 65%, such as less than 60%, less than 55%, less than 50%, less than 48%, less than 46%, less than 44%, less than 42%, less than 40%, less than 48%, or less than 36% for example.

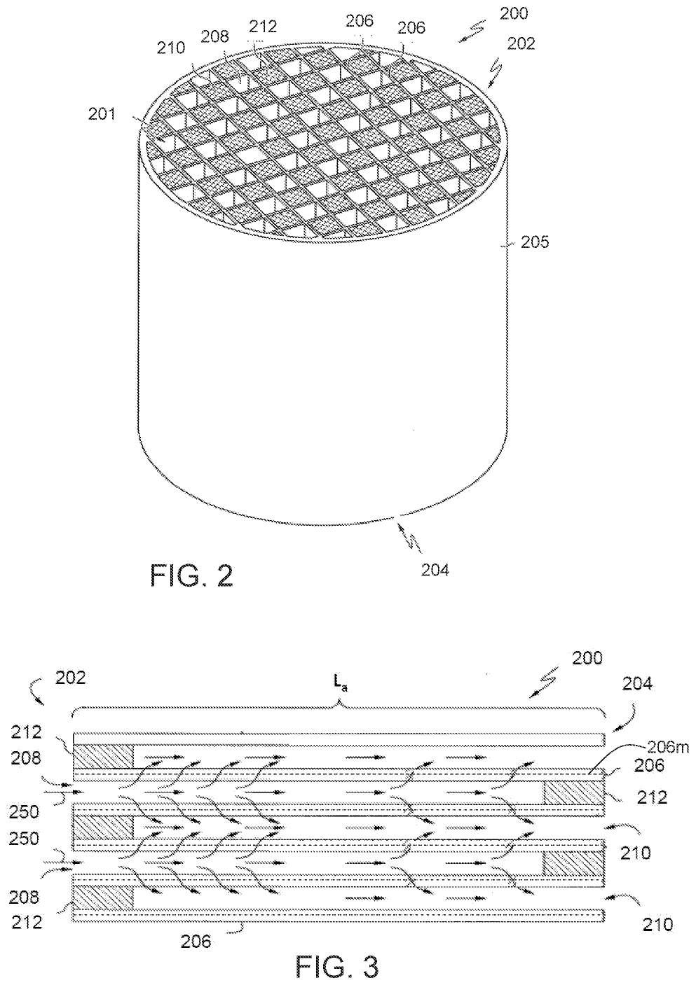

Referring now to FIGS. 2-3, a honeycomb body in the form of a particulate filter 200 is schematically depicted. The particulate filter 200 may be used as a wall-flow filter to filter particulate matter from a gas stream 250, such as an exhaust gas stream emitted from a gasoline engine, such as where the particulate filter 200 is a gasoline particulate filter or in other applications a diesel particulate filter. The particulate filter 200 generally comprises a honeycomb body having a plurality of channels 201 or cells which extend between an inlet end 202 and an outlet end 204, defining an overall axial length La (shown in FIG. 3). The channels 201 of the particulate filter 200 are formed by, and at least partially defined by a plurality of intersecting channel walls 206 that extend from the inlet end 202 to the outlet end 204. The particulate filter 200 may also include a skin layer 205 surrounding the plurality of channels 201. This skin layer 205 may be extruded during the formation of the channel walls 206 or formed in later processing as an after-applied skin layer, such as by applying a skinning cement to the outer peripheral portion of the channels.

A cross-sectional longitudinal view of the particulate filter 200 of FIG. 2 is shown in FIG. 3. In embodiments, certain channels are designated as inlet channels 208 and certain other channels are designated as outlet channels 210. In embodiments of the particulate filter 200, at least a first set of channels may be plugged with plugs 212. Generally, the plugs 212 are arranged proximate the ends (i.e., the inlet end or the outlet end) of the channels 201. The plugs are generally arranged in a pre-defined pattern, such as in the checkerboard pattern shown in FIG. 2, with every other channel being plugged at an end. The inlet channels 208 may be plugged at or near the outlet end 204, and the outlet channels 210 may be plugged at or near the inlet end 202 on channels not corresponding to the inlet channels, as depicted in FIG. 3. Accordingly, each cell may be plugged at or near one end of the particulate filter only. The intersecting channel walls 206 are porous such that the gas stream 250 flows through a thickness of the walls, as well as in an axial direction, and overall in the direction of the arrows, from inlet channels 208 to the outlet channels 210. The porous ceramic walls have an average wall thickness. A midpoint 206m is one-half of the average wall thickness.

While FIG. 2 generally depicts a checkerboard plugging pattern, it should be understood that alternative plugging patterns may be used in the porous ceramic honeycomb article. In the embodiments described herein, the particulate filter 200 may be formed with a channel density of up to about 600 channels per square inch (cpsi). For example, in embodiments, the particulate filter 100 may have a channel density in a range from about 100 cpsi to about 600 cpsi. In other embodiments, the particulate filter 100 may have a channel density in a range from about 100 cpsi to about 400 cpsi or even from about 200 cpsi to about 300 cpsi.

In the embodiments described herein, the channel walls 206 of the particulate filter 200 may have a thickness of greater than about 4 mils (101.6 microns). For example, in embodiments, the thickness of the channel walls 206 may be in a range from about 4 mils up to about 30 mils (762 microns). In other embodiments, the thickness of the channel walls 206 may be in a range from about 7 mils (177.8 microns) to about 20 mils (508 microns).

In embodiments of the particulate filter 200 described herein the channel walls 206 of the particulate filter 200 may have a bare open porosity (i.e., the porosity before any coating is applied to the honeycomb body) % P≥35% prior to the application of any coating to the particulate filter 200. In embodiments the bare open porosity of the channel walls 206 may be such that 40%≤% P≤75%. In other embodiments, the bare open porosity of the channel walls 206 may be such that 45%≤% P≤75%, 50%≤% P≤75%, 55%≤% P≤75%, 60%≤% P≤75%, 45%≤% P≤70%, 50%≤% P≤70%, 55%≤% P≤70%, or 60%≤% P≤70%.

Further, in embodiments, the channel walls 206 of the particulate filter 200 are formed such that the pore distribution in the channel walls 206 has a median pore size of ≤30 microns prior to the application of any coatings (i.e., bare). For example, in embodiments, the median pore size may be ≥8 microns and less than or ≤30 microns. In other embodiments, the median pore size may be ≥10 microns and less than or ≤30 microns. In other embodiments, the median pore size may be ≥10 microns and less than or ≤25 microns. In embodiments, particulate filters produced with a median pore size greater than about 30 microns have reduced filtration efficiency while with particulate filters produced with a median pore size less than about 8 microns may be difficult to infiltrate the pores with a washcoat containing a catalyst. Accordingly, in embodiments, it is desirable to maintain the median pore size of the channel wall in a range of from about 8 microns to about 30 microns, for example, in a range of from 10 microns to about 20 microns.

In one or more embodiments described herein, the honeycomb body of the particulate filter 200 is formed from a metal or ceramic material such as, for example, cordierite, silicon carbide, aluminum oxide, aluminum titanate or any other ceramic material suitable for use in elevated temperature particulate filtration applications. For example, the particulate filter 200 may be formed from cordierite by mixing a batch of ceramic precursor materials which may include constituent materials suitable for producing a ceramic article which predominately comprises a cordierite crystalline phase. In general, the constituent materials suitable for cordierite formation include a combination of inorganic components including talc, a silica-forming source, and an alumina-forming source. The batch composition may additionally comprise clay, such as, for example, kaolin clay. The cordierite precursor batch composition may also contain organic components, such as organic pore formers, which are added to the batch mixture to achieve the desired pore size distribution. For example, the batch composition may comprise a starch which is suitable for use as a pore former and/or other processing aids. Alternatively, the constituent materials may comprise one or more cordierite powders suitable for forming a sintered cordierite honeycomb structure upon firing as well as an organic pore former material.

The batch composition may additionally comprise one or more processing aids such as, for example, a binder and a liquid vehicle, such as water or a suitable solvent. The processing aids are added to the batch mixture to plasticize the batch mixture and to generally improve processing, maintain shape, reduce the drying time, reduce cracking upon firing, and/or aid in producing the desired properties in the honeycomb body. For example, the binder can include an organic binder. Suitable organic binders include water soluble cellulose ether binders such as methylcellulose, hydroxypropyl methylcellulose, methylcellulose derivatives, hydroxyethyl acrylate, polyvinylalcohol, and/or any combinations thereof. Incorporation of the organic binder into the plasticized batch composition allows the plasticized batch composition to be readily extruded and/or to maintain shape of the extrudate. In embodiments, the batch composition may include one or more optional forming or processing aids such as, for example, a lubricant which assists in the extrusion of the plasticized batch mixture. Exemplary lubricants can include tall oil, sodium stearate or other suitable lubricants.

After the batch of ceramic precursor materials is mixed with the appropriate processing aids, the batch of ceramic precursor materials is extruded and dried to form a self-standing green honeycomb body comprising an inlet end and an outlet end with a plurality of channel walls extending between the inlet end and the outlet end. Thereafter, the green honeycomb body is fired according to a firing schedule suitable for producing a fired honeycomb body. At least a first set of the channels of the fired honeycomb body are then plugged in a predefined plugging pattern with a plugging composition such as a ceramic plugging composition and the fired honeycomb body is again fired to fuse or calcine or ceram the plugs and secure the plugs in the channels.

Generally, with respect to FIG. 5, a method for preparing fluid treatment articles herein, including filtration articles having catalytic material, comprises: an operation 454 of applying a catalytic material within a plugged honeycomb body—at an outlet side of the honeycomb body, after the inorganic deposits are applied to the honeycomb body 450. Preferably any hydrophobicity in the porous walls of matrix of the honeycomb body is reduced, more preferably removed, for example by post treatment of the honeycomb body 454, such as by heat treatment after deposition of the inorganic deposits. Embodiments of post treatment are disclosed herein and below. The plugged honeycomb body includes a plurality of channels comprised of inlet channels which are plugged at a distal end of the plugged honeycomb filter body and outlet channels which are plugged at a proximal end of the plugged honeycomb filter body. In one or more embodiments, the catalyst material is applied by coating the catalytic material. In one or more embodiments, the catalytic material is applied as a slurry. With respect to at an outlet side refers to on or within walls defining the outlet channels of the plugged honeycomb body. In embodiments, a majority of the catalytic material is disposed separate from a majority or all of the inorganic deposits by interposing regions located between the inlet sides and the outlet sides of the porous ceramic base portions.

In one or more embodiments, the catalytic material is applied at the outlet sides such that a desired amount of catalytic material is disposed on, in, or on and in the walls, without the catalytic material reaching the inlet sides to yield a catalytically dense region. In one or more embodiments, penetrability of the catalytic material into the porous ceramic base portions is reduced by one or more of the following: increasing slurry viscosity, increasing slurry particle size of the catalytic material, and increasing concentration of the catalytic material in the slurry. In one or more embodiments, a thickness of the catalytically dense region is increased by one or more of the following: decreasing slurry viscosity, increasing slurry particle size of the catalytic material, and increasing concentration of the catalytic material in the slurry.

At operation 450, particles of an inorganic material are applied or disposed at inlet sides of porous ceramic base portions of porous walls of the plugged honeycomb body. Disposed at inlet sides refers to on or within walls defining the inlet channels of the plugged honeycomb body. In one or more embodiments, exposing the plugged honeycomb filter body to a surface treatment to deposit the inorganic material at the inlet sides yields an inorganic deposit region.

In one or more embodiments, a majority of the catalytic material is spaced away from a majority or all of the inorganic deposits at a given axial location by interposing regions disposed between the inorganic deposit region and the catalytically dense region. In one or more embodiments, a majority of the catalytic material is spaced away from a majority or all of the inorganic deposits across the entire axial length by interposing regions disposed between the inorganic deposit region and the catalytically dense region.

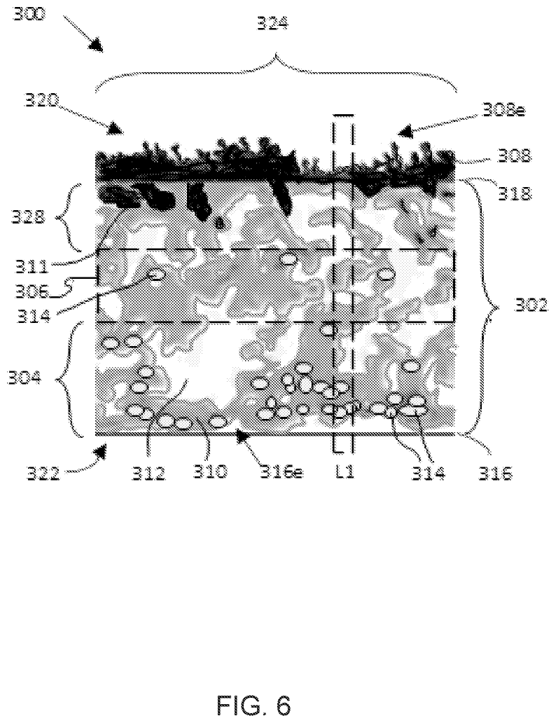

FIG. 6 is a cross-sectional schematic view of a portion of a porous wall 300 according to embodiments disclosed herein. The porous wall 300 comprises a porous ceramic base portion 302 with a plurality of pores 312 and a ceramic structure 310. An average thickness of the porous ceramic base portion 302 may be determined by an overall average thickness (all porous ceramic base portions in the honeycomb body) along entire axial length from a proximal end (inlet) to a distal end (outlet). The porous ceramic base portion 302 comprises an inlet side 320 having an inlet surface 324, and an outlet side 322 having an outlet surface 326. Inorganic deposits 308 are disposed at the inlet side 320 in a layer. In this embodiment, the inlet surface 324 is comprised of exposed inorganic deposits 308e. In this embodiment, the inorganic deposits 308 are in pores 311 and on surfaces 318 of the ceramic base portion 302 at the inlet side 320.

A combination of the inlet surfaces of all of the porous walls of the honeycomb body define the inlet channels of the honeycomb body. A deposited surface portion or inorganic deposit region 328 extends from a first (inlet side) surface 318 of the porous ceramic base portion 302 toward a center or bulk portion or interposing region 306 of the porous ceramic base portion 302.

Catalytic material 314 is disposed at the outlet side 322. In this embodiment, the outlet surface 326 is comprised of any exposed areas 316e of a second (outlet side) surface 316 of the ceramic base portion 302. In this embodiment, the catalytic material 314 is in pores of the ceramic base portion 302 at the outlet side 322.

A catalytically dense region 304 including the catalytic material 314 is at the outlet side 322 of the porous ceramic base portion 302. The catalytically dense region 304 extends from the second (outlet side) surface 316 of the porous ceramic base portion 302 toward the center or bulk portion or interposing region 306.

The center or bulk portion or interposing region 306 is located between the inlet side 320 and the outlet side 322. In this embodiment all of the inorganic deposits 308 are spaced away from a majority of the catalytic material 314 by the interposing region 306. With specific regard to axial location “L1”, all of the catalytic material 314 is spaced away from the inorganic deposits 308.

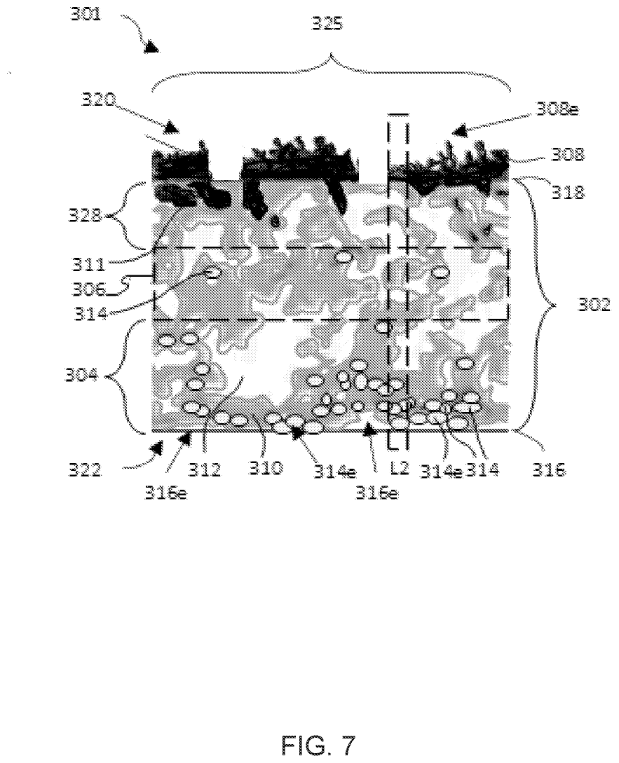

FIG. 7 is a cross-sectional schematic view of a portion of a porous wall 301 according to embodiments disclosed herein. The porous wall 301 comprises a porous ceramic base portion 302 with a plurality of pores 312 and a ceramic structure 310. An average thickness of the porous ceramic base portion 302 may be determined by an overall average thickness (all porous ceramic base portions in the honeycomb body) along entire axial length from a proximal end (inlet) to a distal end (outlet). The porous ceramic base portion 302 comprises an inlet side 320 having an inlet surface 325, and an outlet side 322 having an outlet surface 327. Inorganic deposits 309 are disposed at the inlet side 320 in discontinuous sections. In this embodiment, the inlet surface 325 is comprised of exposed inorganic deposits 309e and exposed portions of a first (inlet side) surface 318 of the ceramic base portion 302. In this embodiment, the inorganic deposits 309 are in pores 311 and discontinuously on surfaces 318 of the ceramic base portion 302 at the inlet side 320.

A combination of the inlet surfaces of all of the porous walls of the honeycomb body define the inlet channels of the honeycomb body. A deposited surface portion or inorganic deposit region 328 extends from the first (inlet side) surface 318 of the porous ceramic base portion 302 toward a center or bulk portion or interposing region 306 of the porous ceramic base portion 302.

Catalytic material 314 is disposed at the outlet side 322. In this embodiment, the outlet surface 327 is comprised of any exposed areas 316e of a second (outlet side) surface 316 of the ceramic base portion 302 and exposed catalytic material 314e. In this embodiment, the catalytic material 314 is in pores of the ceramic base portion 302 and on the second (outlet side surface) 316 at the outlet side 322.

A catalytically dense region 304 including the catalytic material 314 is at the outlet side 322 of the porous ceramic base portion 302. The catalytically dense region 304 extends from the second (outlet side) surface 316 of the porous ceramic base portion 302 toward the center or bulk portion or interposing region 306.

The center or bulk portion or interposing region 306 is located between the inlet side 320 and the outlet side 322. In this embodiment all of the inorganic deposits 309 are spaced away from a majority of the catalytic material 314 by the interposing region 306. With specific regard to axial location “L2”, all of the catalytic material 314 is spaced away from the inorganic deposits 309.

In one or more embodiments, a majority of the catalytic material is spaced away from a majority or all of the inorganic deposits at a given axial location by interposing regions disposed between the inorganic deposit region and the catalytically dense region. In one or more embodiments, a majority of the catalytic material is spaced away from a majority or all of the inorganic deposits across the entire axial length by interposing regions disposed between the inorganic deposit region and the catalytically dense region.

In one or more embodiments, the interposing regions contain less than 5% of the catalytic material, if any, which is disposed on a respective wall at the given axial location. In one or more embodiments, the substantially all or all of the inorganic deposits are spaced away from the catalytic material by the interposing region in one or more of the porous walls. In one or more embodiments, the inorganic deposits are spaced away from the catalytic material by the interposing regions in one or more of the porous walls. In one or more embodiments, the interposing regions comprise greater than or equal to 0.0 to less than or equal to 5.0% of an amount of the catalytic material within the honeycomb body, and all values and subranges therebetween. In one or more embodiments, the interposing regions comprise less than 5.0% of an amount of the catalytic material at the given axial location. In one or more embodiments, the interposing regions are free of the catalytic material. In one or more embodiments, the interposing regions are free of the inorganic deposits. In one or more embodiments, the interposing regions are free of the inorganic deposits and the catalytic material. In one or more embodiments, the inorganic deposits and the catalytic material are mostly physically separated across a thickness of the intersection porous filter walls. In one or more embodiments, the catalytic material substantially does not touch the inorganic deposits. In one or more embodiments, the catalytic material substantially does not touch the inorganic deposits at the axial location. In one or more embodiments, the catalytic material substantially does not touch the inorganic deposits at all axial locations in the filter body.

In one or more embodiments, a thickness of the interposing region relative to the thickness of the base portion is between 0.05 and 0.95, including all values and subranges therebetween, including between 0.1 and 0.90, and between 0.25 and 0.75.

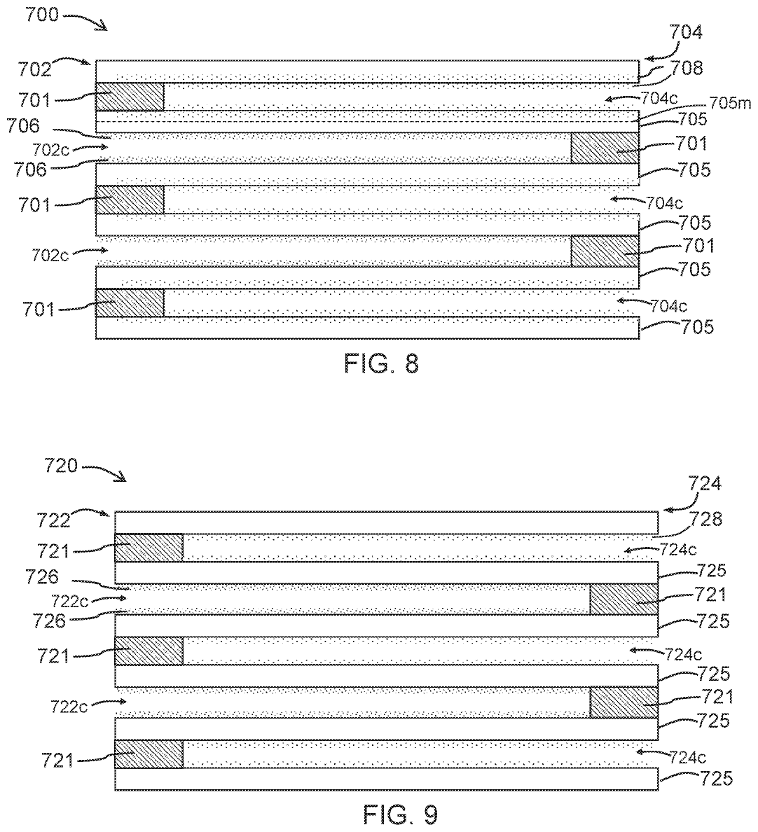

FIG. 8 is an axial cross-sectional schematic view of an article 700 according to embodiments disclosed herein. In one or more embodiments, the article 700 is effective for filtration of particulates from gaseous streams and/or for catalytically converting combustion by-products. In accordance with FIG. 8, inorganic deposits 706 and a catalytic material 708, such as a three-way conversion (TWC) catalytic material, are deposited within a wall flow particulate filter, which has inlet channels 702c, which are plugged at a distal end 702 of the plugged honeycomb filter body and outlet channels 704c, which are plugged at a proximal end 704 of the plugged honeycomb filter body. The article 700 may be used as an article to treat an exhaust gas stream, such as an exhaust gas stream emitted from a gasoline engine or a diesel engine, which enters the article at the proximal (or first/inlet) end 702 and travels along a plurality of inlet channels 702c, through walls 705, and exits along a plurality of outlet channels 704c at the distal (or second/outlet) end 704. The article 700 includes a first set of channels (e.g., inlet channels) 702c that are plugged with plugs 701 at the second/outlet end 704. The article 700 includes a second set of channels (e.g., outlet channels) 704c that are plugged with plugs 701 at the distal (first/inlet) end 702. In this embodiment, the inorganic deposits 706 are on surfaces and/or within pores within an area of the base portions of the walls 705 that face the inlet channels 702c. Thus, inorganic deposits may be found in an inorganic deposit region that may lie on the base portion that faces an inlet channel, and/or may penetrate into the pores (within the pores) of part of the base portion nearer the inlet channel, but preferably does not extend to the opposite side of the same wall base portion that faces an outlet channel. The catalytic material 708 is on surfaces and/or within pores within an area of the base portion of the walls 705 that face the outlet channels 704c. Thus, catalytic material may be found in a catalytically dense region that may lie on the base portion that faces an outlet channel, and/or may penetrate into the pores (within the pores) of part of the base portion nearer the outlet channel, but preferably does not extend to the opposite side of the same wall base portion that faces the inlet channel. Preferably there is an absence of the catalytic material on walls which define the inlet channels 702c of the plugged honeycomb filter body. Preferably the base wall portion comprises an interposing region located between the inlet sides and the outlet sides of the base portions, wherein the interposing regions contain less than 5% of the catalytic material, if any, which is disposed on a respective wall at a given axial location, such that most or all of the inorganic deposits are spaced away from the majority of the catalytic material by the interposing regions. The interposing region may be a catalytically sparse region with very small amounts of catalytic material, or may be free of catalytic material as a catalytic free region. The interposing region is preferably an inorganic deposit free region with very small amounts of catalytic material, or more preferably is free of inorganic deposit material as an inorganic deposit free region. Accordingly, there is lateral separation, or substantial spatial separation, in a normal direction through the thickness of the wall, between most or all of the inorganic deposits 706 and most or all of the catalytic material 708. The catalytic material 708 may be located both on surfaces of the walls 705 and within the pores of the outlet side of the article. Thus, after application of the catalytic material and after deposition of the inorganic material, the walls comprise inlet surfaces facing toward the inlet channels and outlet side surfaces facing toward the outlet channels, and inorganic deposits disposed at the inlet sides of the base portions of the walls, wherein the inlet surfaces are comprised of exposed inorganic deposits facing out toward the inlet channels and any exposed areas of the base portions on the inlet side facing out toward the inlet channels, which inlet surfaces therefore define the inlet channels of the plugged honeycomb filter body; additionally, catalytic material disposed at the outlet sides of the base portions of the walls on and/or within the base portions of the walls at the outlet side, wherein the outlet surfaces are comprised of any exposed catalytic material disposed at the outlet sides of the base portions facing out toward the outlet channel and any exposed areas of the base portions on the outlet side define the outlet channels; and preferably the base portions comprise interposing regions (for example buffer regions or sparse regions) located between the inlet sides and the outlet sides of the base portions. A majority or all of the inorganic deposits are spaced away from a majority of the catalytic material by interposing regions at a given axial location. In one or more embodiments, the interposing regions contain less than 5% of the catalytic material, if any, which is disposed on a respective wall at a given axial location, such that most or all of the inorganic deposits are spaced away from the majority of the catalytic material by the interposing regions.

FIG. 9 is an axial cross-sectional schematic view of an article 720 according to embodiments disclosed herein. In one or more embodiments, the article 720 is effective for filtration of particulates from gaseous streams and/or for catalytically converting combustion by-products. In accordance with FIG. 9, inorganic deposits 726 and a catalytic material 728, such as a three-way conversion (TWC) catalytic material, are deposited within a wall flow particulate filter, which has inlet channels 722c, which are plugged at a distal end 722 of the plugged honeycomb filter body and outlet channels 724c, which are plugged at a proximal end 724 of the plugged honeycomb filter body. The article 720 may be used as an article to treat an exhaust gas stream, such as an exhaust gas stream emitted from a gasoline engine or a diesel engine, which enters the article at the proximal (or first/inlet) end 722 and travels along a plurality of inlet channels 722c, through walls 725, and exits along a plurality of outlet channels 724c at the distal (or second/outlet) end 724. The article 720 includes a first set of channels 722c that are plugged with plugs 721 at the second/outlet end 724. The article 720 includes a second set of channels 724c that are plugged with plugs 721 at the proximal (first/inlet) end 722. In this embodiment, the inorganic deposits 726 are on surfaces of the walls 725 of the inlet channels 722c. The catalytic material 728 is on surfaces of the walls 725 of the outlet channels 724c, with minimal penetration into pores of the walls. Accordingly, there is lateral separation between the inorganic deposits 726 and the catalytic material 728 based on being on different sides of the walls 725.

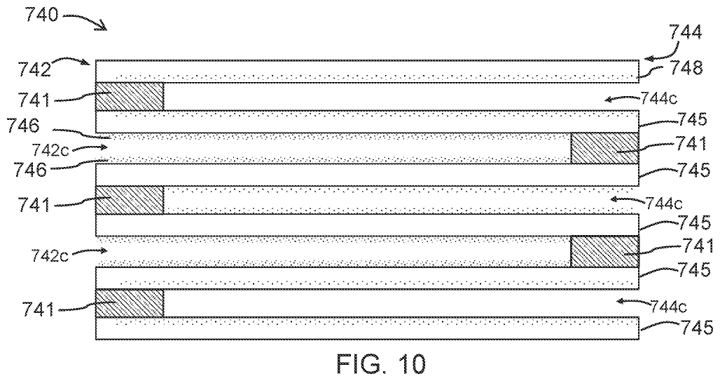

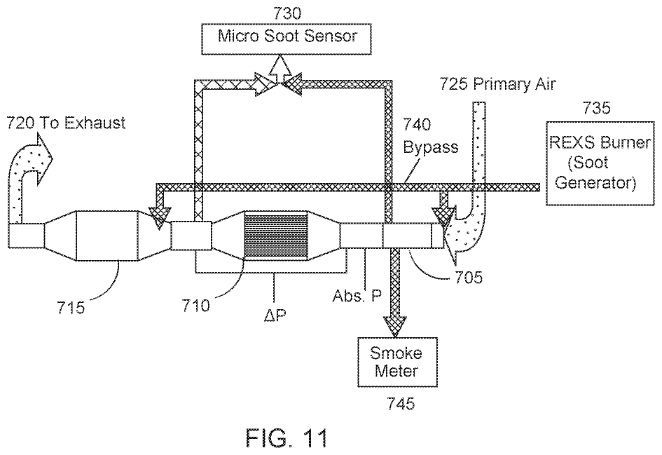

FIG. 10 is an axial cross-sectional schematic view of an article 740 according to embodiments disclosed herein. In one or more embodiments, the article 740 is effective for filtration of particulates from gaseous streams and/or for catalytically converting combustion by-products. In accordance with FIG. 10, inorganic deposits 746 and a catalytic material 748, such as a three-way conversion (TWC) catalytic material, is deposited within a wall flow particulate filter, which has inlet channels 742c, which are plugged at a distal end 742 of the plugged honeycomb filter body and outlet channels 744c, which are plugged at a proximal end 744 of the plugged honeycomb filter body. The article 740 may be used as an article to treat an exhaust gas stream, such as an exhaust gas stream emitted from a gasoline engine or a diesel engine, which enters the article at the proximal (or first/inlet) end 742 and travels along a plurality of inlet channels 742c, through walls 745, and exits along a plurality of outlet channels 744c at the distal (or second/outlet) end 744. The article 740 includes a first set of channels 742c that are plugged with plugs 741 at the second/outlet end 744. The article 740 includes a second set of channels 744c that are plugged with plugs 741 at the proximal (first/inlet) end 742. In this embodiment, the inorganic deposits 746 are on surfaces of the walls 745 of the inlet channels 742c. The catalytic material 748 is within pores of the walls 745 of the outlet channels 744c, with minimal deposition on surfaces walls 745 of the outlet channels 744c. Accordingly, there is lateral separation between the inorganic deposits 746 and the catalytic material 748 based on being on different sides of the walls 745.

In various embodiments, the inorganic material in the form of deposits is effective to filter particulate matter from a gas stream, for example, an exhaust gas stream from a gasoline engine. Accordingly, the median pore size, porosity, geometry and other design aspects of both the bulk and the surfaces of the base portions of the honeycomb body are selected taking into account these filtration requirements of the honeycomb body. Particles of the inorganic material that are deposited on the base portion of the wall of the honeycomb body and help prevent particulate matter, such as, for example, soot and ash, from exiting the honeycomb body and to help accelerate the buildup of particulate matter and therefore the filtration efficiency without clogging the base portion of the walls of the honeycomb body. In this way, and according to embodiments, the inorganic deposits can serve as an enhanced filtration component while the porous ceramic walls of the honeycomb body also provide filtration and can be configured to otherwise minimize pressure drop for example as compared to conventional honeycomb bodies without such layer. As will be described in further detail herein, the inorganic deposit regions may be formed by a suitable method, such as, for example, an aerosol deposition method. Aerosol deposition enables the formation porous deposits which may be in the form of a thin, porous layer on at least some areas of the walls of the honeycomb body.

According to one or more embodiments, a process is disclosed herein which comprises forming an aerosol with a binder process, which is deposited on a honeycomb body to provide a high filtration efficiency material, which may be an inorganic layer, on the honeycomb body to provide a particulate filter. According to one or more embodiments, the process can comprise the steps of mixture preparation, atomization, drying, and deposition of material on the walls of a wall flow filter and heat treatment to effect curing or fusing. In embodiments the inorganic deposits be imparted with a high mechanical integrity even without sintering steps (e.g., heating to temperatures in excess of 1000° C.) by aerosol deposition with binder, although in other embodiments the deposits may be sintered.

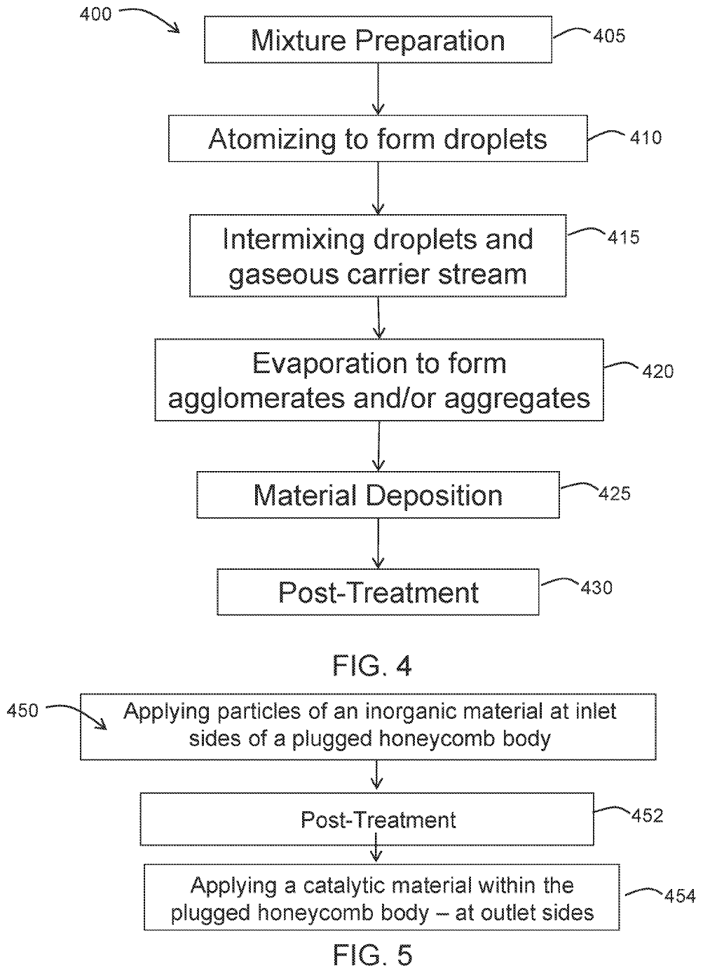

According to one or more embodiments, an exemplary process flow 400 according to FIG. 4 for applying or depositing particles of an inorganic material on one or more portions of porous ceramic walls of a honeycomb body according to FIG. 5 at operation 454 includes: mixture preparation 405, atomizing to form droplets 410, intermixing droplets and a gaseous carrier stream 415; evaporating liquid vehicle to form agglomerates and/or aggregates 420, depositing of material, e.g., agglomerates, on the walls of a wall-flow filter 425, and optional post-treatment 430 to, for example, bind the material on, or in, or both on and in, the porous walls of the honeycomb body. Aerosol deposition methods form of agglomerates comprising a binder can provide a high mechanical integrity even without any high temperature curing steps (e.g., heating to temperatures in excess of 1000° C.), and in embodiments even higher mechanical integrity after a curing step such as a high temperature (e.g., heating to temperatures in excess of 1000° C.) curing step.

Mixture preparation 405. Inorganic particles can be used as a raw material in a mixture for depositing. According to one or more embodiments, the particles are selected from Al₂O₃, SiO₂, TiO₂, CeO₂, ZrO₂, SiC, MgO and combinations thereof. In one or more embodiments, the mixture is a suspension. The particles may be supplied as a raw material suspended in a liquid vehicle to which a further liquid vehicle is optionally added.

In embodiments, the suspension is aqueous-based, and in other embodiments, the suspension is organic-based, for example, an alcohol such as ethanol or methanol.

The solution is formed using a solvent which is added to dilute the suspension if needed. Decreasing the solids content in the solution could reduce the aggregate size proportionally if the droplet generated by atomizing has similar size. The solvent should be miscible with suspension mentioned above, and be a solvent for binder and other ingredients.

A binder is optionally added to reinforce the starting material for forming agglomerates, which comprises inorganic binder, to provide mechanical integrity to deposited material, including after deposition. The binder preferably provides binding strength between particles after exposure to elevated temperature (>500° C.). The starting material can include both inorganic and organic components. After exposure to high temperature in excess of about 150° C., the organic component will preferably decompose or react with moisture and oxygen in the air. Suitable binders include but are not limited to alkoxy-siloxane resins. In one or more embodiments, the alkoxy-siloxane resins are reactive during processing. An exemplary reactive alkoxy-siloxane resin (methoxy functional) prior to processing has a specific gravity of 1.1 at 25° C. Another exemplary reactive alkoxy-siloxane resin (methyl-methoxy functional) prior to processing has a specific gravity of 1.155 at 25° C.

Catalyst can be added to accelerate the cure reaction of binder. A catalyst that can be used to accelerate the cure reaction of reactive alkoxy-siloxane resins is titanium butoxide.

Atomizing to form droplets 410. The mixture is atomized into fine droplets by high pressure gas through a nozzle. The atomizing gas contributes to breaking up the liquid-particulate-binder stream into the droplets. The pressure of the atomizing gas is in the range of 20 psi to 150 psi. The pressure of the liquid is in the range of 1 to 100 psi. The average droplet size according to one or more embodiments is in the range of from 1 micrometer to 40 micrometer s, for example, in a range of from 5 micrometer s to 10 micrometer s. The droplet size can be adjusted by adjusting the surface tension of the solution, viscosity of the solution, density of the solution, gas flow rate, gas pressure, liquid flow rate, liquid pressure, and/or nozzle design. In one or more embodiments, the atomizing gas comprises air, nitrogen or mixture thereof. In specific embodiments, the atomizing gas and the apparatus does not comprise air.

Intermixing droplets and gaseous carrier stream 415. The droplets are conveyed toward the honeycomb body by a gaseous carrier stream. In one or more embodiments, the gaseous carrier stream comprises a carrier gas and the atomizing gas. In one or more embodiments, at least a portion of the carrier gas contacts the atomizing nozzle. In one or more embodiments, substantially all of the liquid vehicle is evaporated from the droplets to form agglomerates comprised of the particles and the binder material.

In one or more embodiments, the gaseous carrier stream is heated prior to being mixed with the droplets. In one or more embodiments, the gaseous carrier stream is at a temperature in the range of from greater than or equal to 50° C. to less than or equal to 500° C., including all greater than or equal to 80° C. to less than or equal to 300° C., greater than or equal to 50° C. to less than or equal to 150° C., and all values and subranges therebetween. Operationally, temperature can be chosen to at least evaporate solvent of the mixture or suspension so long as the final temperature is above the dew point. As non-limiting example, ethanol can be evaporated at a low temperature. Without being held to theory, it is believed that an advantage of a higher temperature is that the droplets evaporate faster and when the liquid is largely evaporated, they are less likely to stick when they collide. In certain embodiments, smaller agglomerates contribute to better filtration material deposits formation. Furthermore, it is believed that if droplets collide but contain only a small amount of liquid (such as only internally), the droplets may not coalesce to a spherical shape. In embodiments, non-spherical agglomerates may provide desirable filtration performance.

Evaporation to Form Agglomerates 420. To avoid liquid capillary force impact which may form non-uniform material which may result in high pressure drop penalty, the droplets are dried in an evaporation section of the apparatus, forming dry solid agglomerates, which may be referred to as secondary particles, or “microparticles” which are made up of primary nanoparticles and binder-type material. The liquid vehicle, or solvent, is evaporated and passes through the honeycomb body in a gaseous or vapor phase so that liquid solvent residual or condensation is minimized during material deposition. When the agglomerate is carried into the honeycomb body by gas flow, the residual liquid in the inorganic material should be less than 10 wt %. All liquid is preferably evaporated as a result of the drying and are converted into a gas or vapor phase. The liquid residual could include solvent in the mixture (such as ethanol in the examples), or water condensed from the gas phase. Binder is not considered as liquid residual, even if some or all of the binder may be in liquid or otherwise non-solid state before cure. In one or more embodiments, a total volumetric flow through the chamber is greater than or equal to 5 Nm³/hour and/or less than or equal to 200 Nm³/hour; including greater than or equal to 20 Nm³/hour and/or less than or equal to 100 Nm³/hour; and all values and subranges therebetween. Higher flow rates can deposit more material than lower flow rates. Higher flow rates can be useful as larger cross-sectional area filters are to be produced. Larger cross-sectional area filters may have applications in filter systems for diesel exhaust, building or outdoor filtration systems.

Deposition in honeycomb body 425. The secondary particles or agglomerates of the primary particles are carried in gas flow, and the secondary particles or agglomerates, and/or aggregates thereof, are deposited on inlet wall surfaces of the honeycomb body when the gas passes through the honeycomb body. In one or more embodiments, the agglomerates and/or aggregates thereof are deposited onto the porous walls of the plugged honeycomb body. The deposited agglomerates may be disposed on, or in, or both on and in, the porous walls. In one or more embodiments, the plugged honeycomb body comprises inlet channels which are plugged at a distal end of the honeycomb body, and outlet channels which are plugged at a proximal end of the honeycomb body. In one or more embodiments, the agglomerates and/or aggregates thereof are deposited on, or in, or both on and in, the walls defining the inlet channels.

The flow can be driven by a fan, a blower and/or a vacuum pump. Additional air can be drawn into the system to achieve a desired flow rate. A desired flow rate is in the range of 5 to 200 m³/hr.

One exemplary honeycomb body is suitable for use as a gasoline particular filter (GPF), and has the following non-limiting characteristics: diameter of 4.055 inches (10.3 cm), length of 5.47 inches (13.9 cm), cells per square inch (CPSI) of 200, wall thickness of 8 mils (203 microns), and average pore size of 14 μm.

In one or more embodiments, the average diameter of the secondary particles or agglomerates is in a range of from 300 nm micron to 10 microns, 300 nm to 8 microns, 300 nm micron to 7 microns, 300 nm micron to 6 microns, 300 nm micron to 5 microns, 300 nm micron to 4 microns, or 300 nm micron to 3 microns. In specific embodiments, the average diameter of the secondary particles or agglomerates is in the range of 1.5 microns to 3 microns, including about 2 microns. The average diameter of the secondary particles or agglomerates can be measured by a scanning electron microscope. Preferably most of the agglomerates are spherical. Aggregates of agglomerates may be spherical or non-spherical.

In one or more embodiments, the average diameter of the secondary particles or agglomerates is in a range of from 300 nm to 10 microns, 300 nm to 8 microns, 300 nm to 7 microns, 300 nm to 6 microns, 300 nm to 5 microns, 300 nm to 4 microns, or 300 nm to 3 microns, including the range of 1.5 microns to 3 microns, and including about 2 microns, and there is a ratio in the average diameter of the secondary particles or agglomerates to the average diameter of the primary particles of in range of from about 2:1 to about 67:1; about 2:1 to about 9:1; about 2:1 to about 8:1; about 2:1 to about 7:1; about 2:1 to about 6:1; about 2:1 to about 5:1; about 3:1 to about 10:1; about 3:1 to about 9:1; about 3:1 to about 8:1; about 3:1 to about 7:1; about 3:1 to about 6:1; about 3:1 to about 5:1; about 4:1 to about 10:1; about 4:1 to about 9:1; about 4:1 to about 8:1; about 4:1 to about 7:1; about 4:1 to about 6:1; about 4:1 to about 5:1; about 5:1 to about 10:1; about 5:1 to about 9:1; about 5:1 to about 8:1; about 5:1 to about 7:1; or about 5:1 to about 6:1, and including about 10:1 to about 20:1.

In one or more embodiments, the depositing of the agglomerates and/or aggregates onto and/or into the porous walls further comprises passing the gaseous carrier stream through the porous walls of the honeycomb body, wherein the walls of the honeycomb body filter out at least some of the agglomerates and/or aggregates by trapping the filtered agglomerates or aggregates on or in the walls of the honeycomb body. In one or more embodiments, the depositing of the agglomerates or aggregates onto the porous walls comprises filtering the agglomerates from the gaseous carrier stream with the porous walls of the plugged honeycomb body.

Post-Treatment 430. A post-treatment or heat treatment is used to adhere the agglomerates to the honeycomb body, and/or to each other. That is, in one or more embodiments, at least some of the agglomerates adhere to the porous walls. In one or more embodiments, the post-treatment comprises heating and/or curing the binder when present according to one or more embodiments. In one or more embodiments, the binder material causes the agglomerates to adhere or stick to the walls of the honeycomb body as well as each other. In one or more embodiments, the binder material tackifies the agglomerates.

Depending on the binder composition, curing conditions may vary. According to embodiments, a low temperature cure reaction is utilized, for example, at a temperature of ≤100° C. In embodiments, the curing can be completed in the vehicle exhaust gas with a temperature ≤950° C. A calcination treatment is optional, which can be performed at a temperature ≤650° C. Exemplary curing conditions are: a temperature range of from 40° C. to 200° C. for 10 minutes to 48 hours.

In one or more embodiments, the porosity of the material, which may be an inorganic layer, disposed on the walls of the honeycomb body, as measured by mercury intrusion porosimetry, SEM, or X-ray tomography is in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%,

As mentioned above, the deposited material, which may be an inorganic layer, on or in walls of the honeycomb body is very thin compared to thickness of the base portion of the walls of the honeycomb body. As discussed herein, the deposited material, which may be an inorganic layer, on the honeycomb body can be formed by methods that permit the material to be applied to surfaces of walls of the honeycomb body in very thin layers. In embodiments, the average thickness of the material, which may be an inorganic layer, on the base portion of the walls of the honeycomb body is greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm.

As discussed above, the material, which may take the form of an inorganic layer, can be applied to the walls of the honeycomb body by methods that permit the inorganic material, which may be an inorganic layer, to have a small median pore size. This small median pore size allows the material, which may be an inorganic layer, to filter a high percentage of particulate and prevents particulate from penetrating the base portion of the walls of the honeycomb and settling into the pores of the honeycomb body, as described above with reference to FIG. 4. The small median pore size of material, which may be an inorganic layer, according to embodiments increases the filtration efficiency of the honeycomb body. In one or more embodiments, the material, which may be an inorganic layer, on the walls of the honeycomb body has a median pore size from greater than or equal to 0.1 μm to less than or equal to 5 μm, such as from greater than or equal to 0.5 μm to less than or equal to 4 μm, or from greater than or equal to 0.6 μm to less than or equal to 3 μm. For example, in embodiments, the material, which may be an inorganic layer, on the walls of the honeycomb body may have median pore sizes of about 0.5 μm, about 0.6 μm, about 0.7 μm, about 0.8 μm, about 0.9 μm, about 1 μm, about 2 μm, about 3 μm, or about 4 μm.

Although the material, which may be an inorganic layer, on the walls of the honeycomb body may, in embodiments, cover substantially 100% of the wall surfaces defining inner channels of the honeycomb body, in other embodiments, the material, which may be an inorganic layer, on the walls of the honeycomb body covers less than substantially 100% of the wall surfaces defining inner channels of the honeycomb body. For instance, in one or more embodiments, the material, which may be an inorganic layer, on the walls of the honeycomb body covers at least 70% of the wall surfaces defining inner channels of the honeycomb body, covers at least 75% of the wall surfaces defining inner channels of the honeycomb body, covers at least 80% of the wall surfaces defining inner channels of the honeycomb body, covers at least 85% of the wall surfaces defining inner channels of the honeycomb body, covers at least 90% of the wall surfaces defining inner channels of the honeycomb body, or covers at least 85% of the wall surfaces defining inner channels of the honeycomb body.

As described above with reference to FIGS. 2 and 3, the honeycomb body can have a first end and second end. The first end and the second end are separated by an axial length. In embodiments, the layer on the walls of the honeycomb body may extend the entire axial length of the honeycomb body (i.e., extends along 100% of the axial length). However, in other embodiments, the material, which may be an inorganic layer, on the walls of the honeycomb body extends along at least 60% of the axial length, such as extends along at least 65% of the axial length, extends along at least 70% of the axial length, extends along at least 75% of the axial length, extends along at least 80% of the axial length, extends along at least 85% of the axial length, extends along at least 90% of the axial length, or extends along at least 95% of the axial length.

In embodiments, the material, which may be an inorganic layer, on the walls of the honeycomb body extends from the first end of the honeycomb body to the second end of the honeycomb body. In embodiments, the material, which may be an inorganic layer, on the walls of the honeycomb body extends the entire distance from the first end of the honeycomb body to the second end of the honeycomb body (i.e., extends along 100% of a distance from the first end of the honeycomb body to the second end of the honeycomb body). However, in one or more embodiments, the layer or material, which may be an inorganic layer, on the walls of the honeycomb body extends along 60% of a distance between the first end of the honeycomb body and the second end of the honeycomb body, such as extends along 65% of a distance between the first end of the honeycomb body and the second end of the honeycomb body, extends along 70% of a distance between the first end of the honeycomb body and the second end of the honeycomb body, extends along 75% of a distance between the first end of the honeycomb body and the second end of the honeycomb body, extends along 80% of a distance between the end surface of the honeycomb body and the second end of the honeycomb body, extends along 85% of a distance between the first end of the honeycomb body and the second end of the honeycomb body, extends along 90% of a distance between the first end of the honeycomb body and the second end of the honeycomb body, or extends along 95% of a distance between the first end of the honeycomb body and the second end of the honeycomb body.

The selection of a honeycomb body having a low pressure drop in combination with the low thickness and high porosity of the layer on the honeycomb body according to embodiments allows a honeycomb body of embodiments to have a low pressure drop when compared to conventional honeycomb bodies. In embodiments, a loading of the inorganic deposits is between 0.1 to 30 g/L on the honeycomb body, such as between 0.1 to 20 g/L on the honeycomb body, or between 0.1 to 10 g/L on the honeycomb body. In other embodiments, the layer is between 0.1 to 20 g/L on the honeycomb body, such as between 0.1 to 10 g/L on the honeycomb body, and such as between 0.5 and 5 g/L. In specific embodiments, the loading of the inorganic material is in a range of from 0.1 to 5 g/L, 0.2 to 4.5 g/L, 0.3 to 4 g/L, 0.4 to 3.5 g/L, 0.5 to 3 g/L, 0.6 to 2.5 g/L, 0.7 to 2 g/L, 1 to 2 g/L on the honeycomb body. Loading of the inorganic material is weight of added material in grams divided by the geometric part volume in liters. The geometric part volume is based on outer dimensions of the honeycomb filter body (or plugged honeycomb body). In embodiments, the pressure drop (i.e., a clean pressure drop without soot or ash) across the honeycomb body compared to a honeycomb without a thin porous inorganic material, which may be an inorganic layer, is less than or equal to 20%, such as less than or equal to 9%, or less than or equal to 8%. In other embodiments, the pressure drop across the honeycomb body is less than or equal to 7%, such as less than or equal to 6%. In still other embodiments, the pressure drop across the honeycomb body is less than or equal to 5%, such as less than or equal to 4%, or less than or equal to 3%.

As stated above, and without being bound to any particular theory, small pore sizes in the layer on the walls of the honeycomb body allow the honeycomb body to have good filtration efficiency even before ash or soot build-up occurs in the honeycomb body. The filtration efficiency of honeycomb bodies is measured herein using the protocol outlined in Tandon et al., 65 CHEMICAL ENGINEERING SCIENCE 4751-60 (2010). As used herein, the initial filtration efficiency of a honeycomb body refers to a new or regenerated honeycomb body that does not comprise any measurable soot loading. In embodiments, the initial filtration efficiency (i.e., clean filtration efficiency) of the honeycomb body is greater than or equal to 70%, such as greater than or equal to 80%, or greater than or equal to 85%. In yet other embodiments, the initial filtration efficiency of the honeycomb body is greater than 90%, such as greater than or equal to 93%, or greater than or equal to 95%, or greater than or equal to 98%.

The material, which may be an inorganic layer, on the walls of the honeycomb body according to embodiments is thin and has a porosity, and in embodiments the layer on walls of the honeycomb body also has good chemical durability and physical stability. The chemical durability and physical stability of the material, which may be an inorganic layer, on the honeycomb body can be determined, in embodiments, by subjecting the honeycomb body to test cycles comprising burn out cycles and an aging test and measuring the initial filtration efficiency before and after the test cycles. For instance, one exemplary method for measuring the chemical durability and the physical stability of the honeycomb body comprises measuring the initial filtration efficiency of a honeycomb body; loading soot onto the honeycomb body under simulated operating conditions; burning out the built up soot at about 650° C.; subjecting the honeycomb body to an aging test at 1050° C. and 10% humidity for 12 hours; and measuring the filtration efficiency of the honeycomb body. Multiple soot build up and burnout cycles may be conducted. A small change in filtration efficiency (ΔFE) from before the test cycles to after the test cycles indicates better chemical durability and physical stability of the material, which may be an inorganic layer, on the honeycomb body. In embodiments, the ΔFE is less than or equal to 5%, such as less than or equal to 4%, or less than or equal to 3%. In other embodiments, the ΔFE is less than or equal to 2%, or less than or equal to 1%.

In embodiments, the material, which may be an inorganic layer, on the walls of the honeycomb body may be comprised of one or a mixture of ceramic components, such as, for example, ceramic components selected from the group consisting of SiO₂, Al₂O₃, MgO, ZrO₂, CaO, TiO₂, CeO₂, Na₂O, Pt, Pd, Ag, Cu, Fe, Ni, and mixtures thereof. Thus, the material, which may be an inorganic layer, on the walls of the honeycomb body may comprise an oxide ceramic. As discussed in more detail below, the method for forming the material, which may be an inorganic layer, on the honeycomb body according to embodiments can allow for customization of the layer composition for a given application. This may be beneficial because the ceramic components may be combined to match, for example, the physical properties—such as, for example coefficient of thermal expansion (CTE) and Young's modulus, etc.—of the honeycomb body, which can improve the physical stability of the honeycomb body. In embodiments, the material, which may be an inorganic layer, on the walls of the honeycomb body may comprise cordierite, aluminum titanate, enstatite, mullite, forsterite, corundum (SIC), spinel, sapphirine, and periclase.

In embodiments, the composition of the material, which may be an inorganic layer, on the walls of the honeycomb body is the same as the composition of the honeycomb body. However, in other embodiments, the composition of the layer is different from the composition of the honeycomb body.

The properties of the material, which may be an inorganic layer, and, in turn, the honeycomb body overall are attributable to the ability of applying a thin, porous material, which may be an inorganic layer, having small median pore sizes to a honeycomb body.

In embodiments, the method of forming a honeycomb body comprises forming or obtaining an aerosol that comprises a ceramic precursor material and a solvent. The ceramic precursor material of the layer precursor comprises conventional raw ceramic materials that serve as a source of, for example, SiO₂, Al₂O₃, TiO₂, MgO, ZrO₂, CaO, CeO₂, Na₂O, Pt, Pd, Ag, Cu, Fe, Ni, and the like.

In one or more embodiments, the aerosol, which is preferably well-dispersed in a fluid, is directed to a honeycomb body, and the aerosol is deposited on the honeycomb body. In embodiments, the honeycomb body may have one or more of the channels plugged on one end, such as, for example, the proximal end or first end 105 of the honeycomb body during the deposition of the aerosol to the honeycomb body. The plugged channels may, in embodiments, be removed after deposition of the aerosol. But, in other embodiments, the channels may remain plugged even after deposition of the aerosol. The pattern of plugging channels of the honeycomb body is not limited In other embodiments, only a portion of the channels of the honeycomb body may be plugged at one end. In such embodiments, the pattern of plugged and unplugged channels at one end of the honeycomb body is not limited and may be, for example, a checkerboard pattern where alternating channels of one end of the honeycomb body are plugged. By plugging all or a portion of the channels at one end of the honeycomb body during deposition of the aerosol, the aerosol may be distributed within the channels 110 of the honeycomb body 100.

Embodiments of honeycomb bodies and methods for forming the same as disclosed and described herein are now provided.

According to one or more embodiments, binders with high temperature (e.g., greater than 400° C.) resistance are included in the inorganic deposits, which may be an inorganic layer, to enhance integrity of the material at high temperatures encountered in automobile exhaust gas emissions treatment systems. In specific embodiments, the inorganic deposits comprise a binder in an amount of about 5 wt %. In one or more embodiments, the binder comprises an alkoxy-siloxane resin. In one or more embodiments, the binder is an inorganic binder. According to one or more embodiments, other potential inorganic and organic binders such as silicate (e.g. Na₂SiO₃), phosphate (e.g. AlPO₄, AlH₂ (PO₄)₃), hydraulic cement (e.g. calcium aluminate), sol (e.g. mSiO₂·nH₂O, Al(OH)ₓ·(H₂O)₆₋ₓ) and metal alkoxides, could also be utilized in the inorganic deposits to increase mechanical strength by an appropriate curing process.

### EXAMPLES

Embodiments will be further understood by the following non-limiting examples.

Pressure drop (dP) of various plugged honeycomb bodies was measured by a rig, which allows a controlled amount of air flow across a test article. A difference in pressure as measured by an upstream senor as compared to a downstream sensor is the reported pressure drop. In a typical measurement, an article is cleaned with compressed air and loaded in the rig. An air flowrate of 210 SCFM (standard ft³/min) was used, with the standard condition defined at 21.1° C. and 1 ATM.

A pressure drop measurement without any soot is called clean dP or clean pressure drop, and is referred to as “dPO”. A pressure drop measured with soot is called soot loaded dP or soot loaded pressure drop, and is referred to as “SLdP”. To load a test article with soot, the test article is loaded with an amount of soot in a separate apparatus. Artificial soot is deposited into the test article using compressed nitrogen (N₂) as a carrier gas. Each apparatus has a designated soot feeder which is connected to a funnel. Once soot is delivered to the funnel by an auger screw, it is pulled into the main exhaust pipe by a venture system. Incremental soot loads are generated in the test article with corresponding weight and pressure drop measured at each level to generate the SLdP profile. The flowrate of nitrogen used to load the soot in the data reported here is 16 ft³/min.

Filtration efficiency (FE) of various plugged honeycomb bodies was measured as follows.

### Filtration Efficiency (FE) Measurements

The filtration efficiency performance (clean and soot-loaded) of the emissions treatment articles herein was evaluated using a filtration efficiency measurement apparatus as shown in FIG. 11.

The setup in FIG. 11 involves generation of soot using a propane burner 735 (Reproducible Exhaust Simulator (REXS burner), Matter Engineering Inc. that is then mixed with primary air 725 before it is introduced to an input pipe 705 to a GPF chamber 710 housing the gasoline particulate filter. The soot generated by the REXS burners is similar to the engine generated soot in terms of soot morphology, chemistry and size distribution. Kasper and Mosimann (2008) (REXS—a reproducible exhaust simulator for the testing of filter materials. SAE Paper No. 2008-01-0759) report REXS generated soot mobility size distribution comparable with engine soot, with mobility mode diameter of 65/85/110 nm, lognormal geometric standard deviation of 1.8 and primary particle diameter of 20-35 nm. Downstream of the chamber 710 is an exhaust flow chamber 715 that directs flow to an exhaust 720.

The choice for the soot concentration levels and the primary air flow rates are made such that the total gas mass flow rates are similar to ones encountered in typical light duty and heavy duty engine applications. To estimate the mass based filtration efficiency, soot mass concentrations are measured upstream and downstream of the filter using AVL photo-acoustic micro-soot sensor (MSS). Prior to testing, the two micro-soot sensors 730 are calibrated with respect to each other by measuring the upstream soot concentration at different levels of primary gas dilution.

The GPF is cleaned with compressed air and loaded on the measurement bench. The system is set in the bypass 740 mode and the primary air is gradually increased to the desired level. The REXS burner is turned on and the system is allowed to stabilized while in the bypass mode. Once the system is stabilized, the soot loaded flow is directed to the main pipe where the GPF is loaded. FE measurement begins and continue as soot is loaded into the filter. The soot concentration downstream of the filter, as measured by MSS, is seen to start at a certain value and then gradually decreases to zero, as the deposited soot act as a filtering medium.

The choice for the soot concentration levels and the primary air flow rates are made depending upon the testing requirement. For the data reported here, the combined burner and primary air flowrate used is 365 SLPM (standard liter/min). The flow rate was chosen so that the filter performance obtained is representative of performance on engine. The soot concentration level used is about 7 mg/m³.

The time step for MSS measurements is set at δt=1 s. Defining the downstream concentration data from MSS as (t′ₖC_{down,k}); k=1, 2, . . . N), the mass based filtration efficiency at any given time t′ₖ is calculated as:

$$FE ( {t}_{k}^{′} ) = 100 \times [ 1 - ( \frac{{C}_{down , k}}{{C}_{up}} ) ] \qquad ( 1 )$$

where Cᵤₚ is the upstream concentration as measured by the micro-soot sensor The corresponding filter soot loading per unit filter volume, SL, at any time, tₖ, is estimated using the following relation:

$$SL ( {t}_{k}^{′} ) = \frac{{\sum }_{j = 1}^{k} {Q}_{T} ( FE ( {t}_{j}^{′} ) / 100 ) {c}_{up} δ t}{{V}_{filter}} \qquad ( 2 )$$

where Q_{T} is the volumetric flow rate to the filter and V_{filter} is the filter volume. As the soot deposits in the filter, the soot itself acts as a filtering medium resulting in the increase of filtration efficiency with time. The filtration efficiency gradually increases from clean filter efficiency to steady state efficiency, reaching 100% efficiency.

### Examples A & B

A series of emissions treatment articles were prepared and tested for pressure drop (dP) and filtration efficiency (FE). Cordierite plugged honeycomb filters (gasoline particulate filters—GPF) used had the following characteristics: diameter of 4.66 inches (11.83 cm), a length of 5 inches 12.7 cm), cells per square inch (CPSI) of 300, and base wall thickness of 8 mils, bulk porosity of 65%, and median pore size of 17.5 μm.

Two samples and their TWC loading, TWC location, inorganic material (e.g. inorganic particulate material) loading, and Clean FE is provided in Table 1. Reference to “clean FE” means there is no soot loaded in the honeycomb body during the measurement.

TABLE 1
ON-WALL TWC

| | | | INLET | |
|---|---|---|---|---|
| | TWC | | total inorganic | |
| | loading | TWC | material loading | |
| Example # | (g/L) | location | (g/L) | Clean FE″ |
| A | — | — | — | 52% |
| (bare) | | | | |
| B | 116 | OUTLET | 9.9 | 97.6% |
| | | on-wall | | |

Example A was a bare GPF. Example B located the TWC on the walls of the outlet channels (e.g., in accordance with FIG. 8).

Inorganic material, or inorganic material particles, were deposited onto GPFs for Example B, and Example 1 by methods disclosed herein according to FIG. 4.

The inorganic material particles were: alumina powder (Al2O3) (primary D50 particle size is 0.7 μm), which was milled in ethanol to a D50 particle size of about 0.37 μm. The deposition parameters were according to Table 2.

TABLE 2

| Parameter | Value |
|---|---|
| Alumina solids loading wt. % | 11% |
| Binder | alkoxy-siloxane |
| | resin (reactive) |
| Binder concentration wt. % (vs. Alumina) | 20% |
| Suspension flow rate (ml/min) | 10 |
| Atomizing gas flow rate (Nm³/h) | 7.4 |
| Total carrier gas flow (m³/h) | 60 |
| Chamber Gas Temperature (° C.) | 150 |

After the inorganic material was applied, the honeycomb body was heat treated at 650 C for 3 hours which completely removed hydrophobicity from the walls, Example B was coated with a simulated three-way conversion (TWC) catalytic material as indicated in Table 2, which did not include any platinum group metals for deposition purposes and pressure drop and filtration testing. A high viscosity slurry of an alumina, an oxygen storage component (Ce—Zr solid solution), and a boehmite binder was prepared. The slurry was deposited by piston coating technique wherein a measured amount of slurry is pushed into the part with the help of a piston. Thereafter, channels of the article were cleared with vacuum. Due to the high viscosity of the slurry, penetration of the slurry material was limited to the outlet side of the base portion of the wall, resulting in an on-wall coating. The slurry material also did not come into contact with the inorganic material, so the inorganic material was protected from being coated with the slurry material. The total washcoat loading (WCL) obtained was about 116 g/L (grams per liter of honeycomb structure volume).

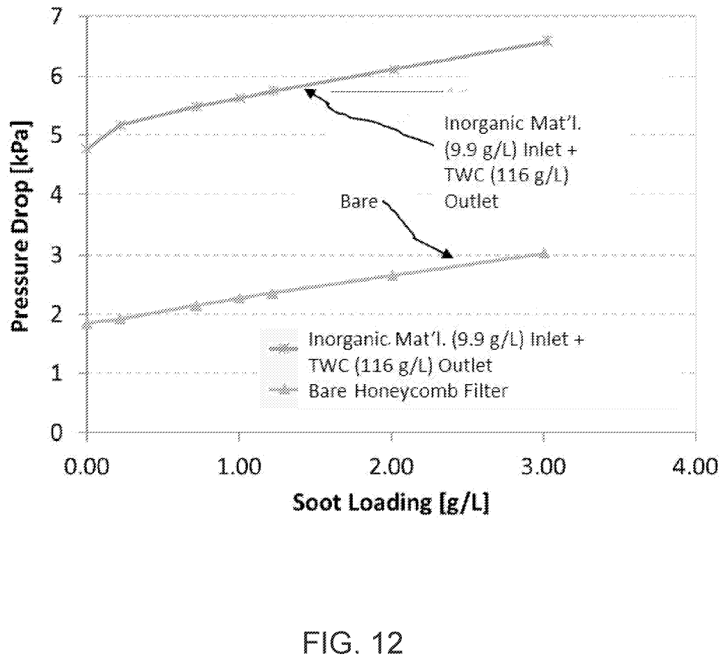

FIG. 12 is a graph of pressure drop (kPa) versus soot loading for Examples A & B. For Example A (bare honeycomb filter), there is lower clean and SL dP penalty as compared to Example B. For Example B (on-wall coating is on the outlet side and deposits of inorganic material particles is on inlet side), there was almost 3 kPa (about 2.6 times) higher clean dP penalty and 3.6 kPa (about 2.2 times) higher SL dP (at 3 g/L soot) penalty compared to Example A.

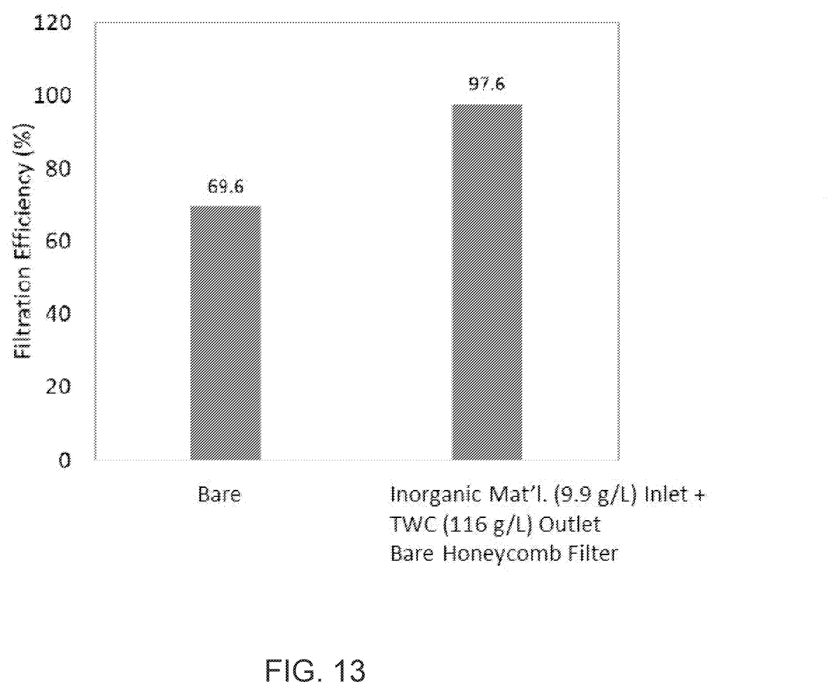

FIG. 13 is a graph of filtration efficiency for a bare honeycomb body example and for a honeycomb body having inorganic material deposited on inlet sides of the walls of the matrix of walls plus catalytic-type material applied to the outlet sides of the walls. Thus while the filter with inorganic material and catalytic type material has an increased pressure drop dP penalty over a bare filter, the SLdP profile is relatively flat and most importantly, very high filtration efficiency can be achieved, even a clean filtration efficiency of 97.6%.

FIG. 13 is a graph of pressure drop (kPa) versus soot loading for Example 2 and Examples C-D. For Example 2, (sided in-wall coating is on the outlet side and inorganic material deposits were on inlet side), there is lower clean and SL dP penalty as compared to Example D. For Example D (in-wall coating is on inlet side), there was almost 12% higher clean dP penalty and 28.8% higher SL dP (at 3 g/L soot) penalty compared to Example 2.

### Example 3—Analysis

Without intending to be bound by theory, these benefits may be due to more uniform flow distribution of carrier gas containing atomized agglomerates of inorganic material when most of the coating is in/on the outlet side. That is when coating is in/on the outlet side, flow distribution of carrier gas containing atomized droplets may be driven by uncoated microstructure which results in relatively uniform deposition of inorganic particulate material on the wall surface compared to coated microstructure.

### EMBODIMENTS

Various embodiments are listed below. It will be understood that the embodiments listed below may be combined with all aspects and other embodiments in accordance with the scope of the invention.

Embodiment (a). A filtration article comprising: a plugged honeycomb filter body comprising: intersecting porous walls extending an axial length in an axial direction from a proximal end to a distal end of the honeycomb body and defining a plurality of axial channels comprised of inlet channels, which are plugged at the distal end of the plugged honeycomb filter body, and outlet channels, which are plugged at the proximal end of the plugged honeycomb filter body, the porous walls comprising: porous ceramic base portions with a plurality of pores and an average thickness and having inlet sides and outlet sides; inlet surfaces defining the inlet channels; outlet surfaces defining the outlet channels; inorganic deposits disposed at the inlet sides of the porous ceramic base portions, the inlet surfaces being comprised of exposed inorganic deposits and any areas of the porous ceramic base portion exposed to the inlet channels; and catalytic material disposed at the outlet sides of the porous ceramic base portions on and/or within the porous ceramic base portions, the outlet surfaces being comprised of any catalytic material exposed to the outlet channels, and any areas of the porous ceramic base portion exposed to the outlet channels; wherein the porous ceramic base portions comprise interposing regions located between the inlet sides and the outlet sides of the porous ceramic base portions, wherein a majority or all of the inorganic deposits are spaced away from a majority of the catalytic material by the interposing region at a given axial location, wherein both the porous ceramic base portions and the inorganic deposits are not hydrophobic.

Embodiment (b). The filtration article of embodiment (a), wherein the interposing regions contain less than 5% of the catalytic material, if any, which is disposed on a respective wall at the given axial location.

Embodiment (c). The filtration article of embodiment (a) or (b), wherein substantially all or all of the inorganic deposits are spaced away from the catalytic material by the interposing region in one or more of the porous walls.

Embodiment (d). The filtration article of any of embodiments (a) to (c), wherein the inorganic deposits are spaced away from the catalytic material by the interposing regions in one or more of the porous walls.

Embodiment (e). The filtration article of any of embodiments (a) to (d), wherein the interposing regions comprise greater than or equal to 0.0 to less than or equal to 5.0% of an amount of the catalytic material within the honeycomb body.

Embodiment (f). The filtration article of any of embodiments (a) to (e), wherein the interposing regions comprise less than 5.0% of an amount of the catalytic material at the given axial location.

Embodiment (g). The filtration article of any of embodiments (a) to (f), wherein the interposing regions are free of the catalytic material.

Embodiment (h). The filtration article of any of embodiments (a) to (g), wherein the interposing regions are free of the inorganic deposits.

Embodiment (i). The filtration article of any of embodiments (a) to (f), wherein the interposing regions are free of the inorganic deposits and the catalytic material.

Embodiment (j). The filtration article of any of embodiments (a) to (i), wherein the catalytic material substantially does not touch the inorganic deposits.

Embodiment (k). The filtration article of any of embodiments (a) to (j), wherein a ratio of a thickness of the interposing regions relative to the thickness of the porous ceramic base portions is between 0.05 and 0.95.

Embodiment (l). The filtration article of embodiment (k), wherein the ratio of the thickness of the interposing regions relative to the thickness of the porous ceramic base portions is between 0.1 and 0.90.

Embodiment (m). The filtration article of embodiment (l), wherein the ratio of the thickness of the interposing regions relative to the thickness of the porous ceramic base portions is between 0.25 and 0.75.

Embodiment (n). The filtration article of any of embodiments (a) to (m), wherein each of the porous ceramic base portions is comprised of: an inorganic deposit region comprised of inorganic deposits disposed on and/or in the porous ceramic base portion at the inlet side thereof; a catalytically dense region comprised of catalytic material disposed on and/or in the porous ceramic base portion at the outlet side thereof; and the interposing region is disposed between the inorganic deposit region and the catalytically dense region.

Embodiment (o). The filtration article of any of embodiments (a) to (n), wherein the inorganic deposits are comprised of porous agglomerates of inorganic material, or aggregates of porous agglomerates of inorganic material.

Embodiment (p). The filtration article of embodiment (o), wherein the agglomerates, or the aggregates, are comprised of nanoparticles.

Embodiment (q). The filtration article of embodiment (p), wherein the nanoparticles are comprised of one or more of: refractory material, metal, ceramic, and glass.

Embodiment (r). The filtration article of embodiment (p), wherein the nanoparticles are comprised of one or more oxides and nitrides.

Embodiment(s). The filtration article of any of embodiments (a) to (r), wherein the inorganic deposits are porous.

Embodiment (t). The filtration article of any of embodiments (a) to (r), wherein the inorganic deposits are non-porous.

Embodiment (u). The filtration article of any of embodiments (a) to (r), wherein the inorganic deposits are comprised of porous ceramic material.

Embodiment (v). The filtration article of any of embodiments (a) to (u), wherein the inorganic deposits are comprised of porous spherical agglomerates of nanoparticles.

Embodiment (w). The filtration article of any of embodiments (a) to (v), wherein the catalytic material is porous.

Embodiment (x). The filtration article of any of embodiments (a) to (v), wherein the catalytic material is non-porous.

Embodiment (y). The filtration article of any of embodiments (a) to (x), wherein a loading of the inorganic deposits disposed within the plugged honeycomb filter body is in a range of greater than or equal to 0.5 to less than or equal to 10 grams of the inorganic deposits per liter of the plugged honeycomb filter body.

Embodiment (z). The filtration article of any of embodiments (a) to (y), wherein the catalytic material comprises a three-way conversion (TWC) catalytic material.

Embodiment (aa). The filtration article of any of embodiments (a) to (z), wherein the inorganic deposits are disposed separate from the TWC catalytic material.

Embodiment (bb). The filtration article of embodiment (z) or (aa), wherein a loading of the TWC catalytic material is in a range of 0.5 g/in³ (30 g/L) to 2.5 g/in³ (150 g/L) of the plugged honeycomb filter body.

Embodiment (cc). The filtration article of any of embodiments (a) to (bb), wherein the inorganic deposits comprise a median pore size in a range of greater than or equal to 0.1 micrometers to less than or equal to 5 micrometers.

Embodiment (dd). The filtration article of any of embodiments (a) to (cc), wherein the porosity of the porous walls is greater than 50% to less than or equal to 70%.

Embodiment (ee). The filtration article of any of embodiments (a) to (dd), wherein the inorganic deposits are present as a continuous coating on the porous walls.

Embodiment (ff). The filtration article of any of embodiments (a) to (ee), wherein the inorganic deposits are comprised of refractory inorganic nanoparticles bound by a binder comprising one or more inorganic components.

Embodiment (gg). The filtration article any of embodiments (a) to (ff), wherein the inorganic deposits are comprised of refractory metal oxide nanoparticles.

Embodiment (hh). The filtration article of embodiment (gg), wherein the nanoparticles comprise alumina.

Embodiment (ii). The filtration article of any of embodiments (a) to (hh), wherein a clean filtration efficiency of the filtration article is greater than or equal to 90% as measured by a clean filtration efficiency test.

Embodiment (jj). A method for making a filtration article comprised of a honeycomb body comprising intersecting porous walls extending an axial length in an axial direction from a proximal end to a distal end of the honeycomb body and defining a plurality of axial channels comprised of inlet channels, which are plugged at or near the distal end of the plugged honeycomb filter body, and outlet channels, which are plugged at or near the proximal end of the plugged honeycomb filter body, wherein the porous walls comprise: porous ceramic base portions with a plurality of pores and an average thickness, and having inlet sides facing the inlet channels and outlet sides facing the outlet channels, the method comprising: depositing inorganic material at the inlet sides of the porous ceramic base portions of the porous walls to yield an inorganic deposit region thereof, then, applying catalytic material at the outlet sides of the porous ceramic base portions of the porous walls such that a desired amount of catalytic material is disposed on, in, or on and in the walls, without the catalytic material reaching the inlet sides, to yield a catalytically dense region thereof, wherein a majority of the catalytic material is spaced away from a majority or all of the inorganic deposits at a given axial location in one or more of the walls by interposing regions disposed between the inorganic deposit region and the catalytically dense region.

Embodiment (kk). The method of embodiment (jj), wherein the interposing regions contain less than 5% of the catalytic material, if any, which is disposed on a respective wall at the given axial location.

Embodiment (ll). The method of embodiment (jj) or (kk), wherein the catalytic material is applied as a slurry.

Embodiment (mm). The method of embodiment (ll), wherein penetrability of the catalytic material into the porous ceramic base portions is reduced by one or more of the following: increasing slurry viscosity, increasing slurry particle size of the catalytic material, and increasing concentration of the catalytic material in the slurry.

Embodiment (nn). The method of embodiment (ll), wherein a thickness of the catalytically dense region is increased by one or more of the following: decreasing slurry viscosity, increasing slurry particle size of the catalytic material, and increasing concentration of the catalytic material in the slurry.

Embodiment (oo). The method of embodiment (jj to nn), wherein hydrophobic material is deposited along with the inorganic material at the inlet sides.

Embodiment (pp). The method of embodiment (jj to oo), further comprising heating the honeycomb body to reduce hydrophobicity in the honeycomb body.

Embodiment (qq). The method of embodiment (jj to pp), further comprising heating the honeycomb body to remove hydrophobicity in the honeycomb body.

Embodiment (rr). The method of embodiment (jj to qq), further comprising heating the honeycomb body to remove all hydrophobicity from the honeycomb body.

Embodiment (ss). The method of embodiment (oo to rr), wherein the hydrophobic material binds particles of the inorganic material to each other and/or to the porous ceramic base portions of the porous walls.

Embodiment (tt). The method of embodiment (jj to ss), wherein the heating binds at least some particles of the inorganic material to each other.

Embodiment (uu). The method of embodiment (jj to tt), wherein the catalytic material is applied as a slurry.

Embodiment (vv). The method of embodiment (uu), wherein the applying catalytic material further comprises adjusting viscosity, catalytic particle size, slurry concentration, or combinations thereof.

Embodiment (ww). The method of embodiment (jj to vv), wherein the honeycomb body is heated to one or more temperatures greater than or equal to 500 C.

Embodiment (xx). The method of embodiment (to ww) wherein a loading of the catalytic material is between 0.5 g/in³ (30 g/L) to 2.5 g/in³ (150 g/L) within the honeycomb body.

Embodiment (aaa). A method for making a filtration article, the method comprising: applying a catalytic material at outlet sides of porous ceramic base portions a plugged honeycomb filter body comprising intersecting porous walls; and exposing the plugged honeycomb filter body to a surface treatment to deposit inorganic deposits at inlet sides of the porous ceramic base portions; wherein a majority of the catalytic material is disposed separate from a majority or all of the inorganic deposits by interposing regions located between the inlet sides and the outlet sides of the porous ceramic base portions.

Embodiment (bbb). The method of embodiment (aaa), wherein a loading of the inorganic deposits disposed within the plugged honeycomb filter body is in a range of greater than or equal to 0.5 to less than or equal to 10 grams of the inorganic deposits per liter of the plugged honeycomb filter body.

Embodiment (ccc). The method of embodiment (aaa) or (bbb), wherein the surface treatment comprises: atomizing particles of an inorganic material into liquid-particulate-binder droplets comprised of a liquid vehicle, a binder material, and the particles; evaporating substantially all of the liquid vehicle from the droplets to form agglomerates and/or aggregates comprised of the particles and the binder material; and depositing the agglomerates and/or aggregates at the inlet sides of the porous ceramic base portions.

Embodiment (ddd). The method of any of embodiments (aaa) to (ccc), wherein the catalytic material comprises a three-way conversion (TWC) catalytic material, and the applying of the catalytic material comprises: preparing a slurry of a platinum group metal (PGM), alumina, and an oxygen storage component; and applying the slurry in the plugged honeycomb filter body.

Embodiment (eee). The method of any of embodiments (aaa) to (eee), wherein loading of the catalytic material is between 0.5 g/in³ (30 g/L) to 2.5 g/in³ (150 g/L) within the honeycomb body.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A filtration article comprising:
a plugged honeycomb filter body comprising:
intersecting porous walls extending an axial length in an axial direction from a proximal end to a distal end of the honeycomb body and defining a plurality of axial channels comprised of inlet channels, which are plugged at the distal end of the plugged honeycomb filter body, and outlet channels, which are plugged at the proximal end of the plugged honeycomb filter body, the porous walls comprising:
porous ceramic base portions with a plurality of pores and an average thickness and having inlet sides and outlet sides:
inlet surfaces defining the inlet channels:
outlet surfaces defining the outlet channels;
inorganic deposits disposed at the inlet sides of the porous ceramic base portions, the inlet surfaces being comprised of exposed inorganic deposits and any areas of the porous ceramic base portion exposed to the inlet channels; and
catalytic material disposed at the outlet sides of the porous ceramic base portions on and/or within the porous ceramic base portions, the outlet surfaces being comprised of any catalytic material exposed to the outlet channels, and any areas of the porous ceramic base portion exposed to the outlet channels;
wherein the porous ceramic base portions comprise interposing regions located between the inlet sides and the outlet sides of the porous ceramic base portions, wherein a majority or all of the inorganic deposits are spaced away from a majority of the catalytic material by the interposing region at a given axial location:
wherein both the porous ceramic base portions and the inorganic deposits are not hydrophobic.

2. The filtration article of claim 1, wherein the interposing regions contain less than 5% of the catalytic material, if any, which is disposed on a respective wall at the given axial location.

3. The filtration article of claim 1, wherein substantially all or all of the inorganic deposits are spaced away from the catalytic material by the interposing region in one or more of the porous walls.

4. The filtration article of claim 1, wherein the inorganic deposits are spaced away from the catalytic material by the interposing regions in one or more of the porous walls.

5. The filtration article of claim 1, wherein the interposing regions comprise greater than or equal to 0.0 to less than or equal to 5.0% of an amount of the catalytic material within the honeycomb body.

6. The filtration article of claim 1, wherein the interposing regions comprise less than 5.0% of an amount of the catalytic material at the given axial location.

7. The filtration article of claim 1, wherein the interposing regions are free of the catalytic material.

8. The filtration article of claim 1, wherein the interposing regions are free of the inorganic deposits.

9. (canceled)

10. (canceled)

11. The filtration article of claim 1, wherein a ratio of a thickness of the interposing regions relative to the thickness of the porous ceramic base portions is between 0.05 and 0.95.

12. (canceled)

13. The filtration article of claim 11, wherein the ratio of the thickness of the interposing regions relative to the thickness of the porous ceramic base portions is between 0.25 and 0.75.

14. The filtration article of claim 1, wherein each of the porous ceramic base portions is comprised of: an inorganic deposit region comprised of inorganic deposits disposed on and/or in the porous ceramic base portion at the inlet side thereof; a catalytically dense region comprised of catalytic material disposed on and/or in the porous ceramic base portion at the outlet side thereof; and the interposing region is disposed between the inorganic deposit region and the catalytically dense region.

15. The filtration article of claim 1, wherein the inorganic deposits are comprised of porous agglomerates of inorganic material, or aggregates of porous agglomerates of inorganic material.

16. (canceled)

17. (canceled)

18. (canceled)

19. (canceled)

20. (canceled)

21. The filtration article of claim 1, wherein the inorganic deposits are comprised of porous ceramic material.

22. The filtration article of claim 1, wherein the inorganic deposits are comprised of porous spherical agglomerates of nanoparticles.

23. (canceled)

24. (canceled)

25. (canceled)

26. The filtration article of claim 1, wherein the catalytic material comprises a three-way conversion (TWC) catalytic material.

27. (canceled)

28. (canceled)

29. The filtration article of claim 1, wherein the inorganic deposits comprise a median pore size in a range of greater than or equal to 0.1 micrometers to less than or equal to 5 micrometers.

30. The filtration article of claim 1, wherein the porosity of the porous walls is greater than 50% to less than or equal to 70%.

31. (canceled)

32. The filtration article of claim 1, wherein the inorganic deposits are comprised of refractory inorganic nanoparticles bound by a binder comprising one or more inorganic components.

33. The filtration article of claim 1, wherein the inorganic deposits are comprised of refractory metal oxide nanoparticles.

34. The filtration article of claim 33, wherein the nanoparticles comprise alumina.

35. The filtration article of claim 1, wherein a clean filtration efficiency of the filtration article is greater than or equal to 90% as measured by a clean filtration efficiency test.

36. A method for making a filtration article comprised of a honeycomb body comprising intersecting porous walls extending an axial length in an axial direction from a proximal end to a distal end of the honeycomb body and defining a plurality of axial channels comprised of inlet channels, which are plugged at or near the distal end of the plugged honeycomb filter body, and outlet channels, which are plugged at or near the proximal end of the plugged honeycomb filter body, wherein the porous walls comprise: porous ceramic base portions with a plurality of pores and an average thickness, and having inlet sides facing the inlet channels and outlet sides facing the outlet channels, the method comprising: depositing inorganic material at the inlet sides of the porous ceramic base portions of the porous walls to yield an inorganic deposit region thereof: then
applying catalytic material at the outlet sides of the porous ceramic base portions of the porous walls such that a desired amount of catalytic material is disposed on, in, or on and in the walls, without the catalytic material reaching the inlet sides, to yield a catalytically dense region thereof;
wherein a majority of the catalytic material is spaced away from a majority or all of the inorganic deposits at a given axial location in one or more of the walls by interposing regions disposed between the inorganic deposit region and the catalytically dense region.

37. The method of claim 36 wherein hydrophobic material is deposited along with the inorganic material at the inlet sides.

38. The method of claim 36 further comprising heating the honeycomb body to reduce hydrophobicity in the honeycomb body.

39. (canceled)

40. (canceled)

41. The method of claim 36 wherein the hydrophobic material binds particles of the inorganic material to each other and/or to the porous ceramic base portions of the porous walls.

42. (canceled)

43. (canceled)

44. (canceled)

45. (canceled)

46. (canceled)

47. (canceled)

48. The method of claim 38, wherein penetrability of the catalytic material into the porous ceramic base portions is reduced by one or more of the following: increasing slurry viscosity, increasing slurry particle size of the catalytic material, and increasing concentration of the catalytic material in the slurry.

49. The method of claim 38, wherein a thickness of the catalytically dense region is increased by one or more of the following: decreasing slurry viscosity, increasing slurry particle size of the catalytic material, and increasing concentration of the catalytic material in the slurry.

50. The method of claim 36 wherein hydrophobic material is deposited along with the inorganic material at the inlet sides.

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)
